(19) United States
(12) Patent Application Publication
(10) Pub. No.: US 2015/0323912 A1
(43) Pub. Date: Nov. 12, 2015

(54) CLOSED LOOP PI/PID CONTROLLER TUNING METHOD FOR STABLE AND INTEGRATING PROCESS WITH TIME DELAY

(71) Applicants: King Fahd University of Petroleum and Minerals, Dhahran (SA); King Abdulaziz City for Science and Technology, Riyadh (SA)

(72) Inventor: Mohammad Shamsuzzoha, Dhahran (SA)

(73) Assignees: King Fahd University of Petroleum and Minerals, Dhahran (SA); King Abdulaziz City for Science and Technology, Riyadh (SA)

(21) Appl. No.: 14/272,561

(22) Filed: May 8, 2014

(51) Int. Cl. G05B 13/02; G06F 17/10

(52) U.S. Cl. CPC G05B 13/0205; G06F 17/10

(57) ABSTRACT

A new online controller tuning method in closed-loop mode improves over the Ziegler-Nichols continuous cycling method. The method is a closed-loop setpoint step experiment PI/PID controller tuning method, which uses a P-controller with a gain K_{c0}, runs a setpoint experiment, and obtains a plurality of PI/PID-controller settings directly from three data from the setpoint experiment, wherein the three data are overshoot (Δyₚ−Δy_{∞})/Δy_{∞}), time to reach overshoot or first peak tₚ, and relative steady state output change b=Δy_{∞}/Δyₛ, wherein Δyₛ is a setpoint change, Δy_{∞} is a steady-state output change after setpoint step test, and Δyₚ is a peak output change at time tₚ.

### BACKGROUND

1. Field of the Invention

The present disclosure relates to a method for closed loop proportional integral (PI)/proportional integral-derivative (PID) controller tuning.

2. Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The proportional, integral and derivative (PID) controller is widely used in the process industries due to its simplicity, robustness and wide ranges of applicability in the regulatory control layer. The stable and integrating processes are very common in process industries in flow, level and temperature loop. Based on a survey of more than 11,000 controllers in the process industries, Desborough and Miller (L. D. Desborough and R. M. Miller, “Increasing customer value of industrial control performance monitoring—Honeywell's experience,” in Chemical Process Control—VI AIChE Symposium Series, Tucson, Ariz., January 2001, 2002, incorporated herein by reference) reported that more than 97% of the regulatory controllers utilize the PI/PID algorithm. A recent survey of Kano and Ogawa (Kano, M.; Ogawa, M. The state of art in chemical process control in Japan: Good practice and questionnaire survey. J. Process Control, 2010, 20, 969-982, incoroprated herein by reference) shows that the ratio of applications of different type of controller e.g. PI/PID control, conventional advanced control and model predictive control is about 100:10:1. Although the PI/PID controller has only few adjustable parameters, they are difficult to be tuned properly in real processes. One reason is that tedious plant tests are required to obtain improved controller setting. Due to this reason, finding a simple PI/PID tuning approach with a significant performance improvement has been an important research issue for process engineers.

There are variety of controller tuning approach reported in the literature (see Seborg, D. E.; Edgar, T. F.; Mellichamp, D. A. Process Dynamics and Control, 2nd ed.; John Wiley & Sons, New York, 2004, Chen, D.; Seborg, D. E. PI/PID controller design based on direct synthesis and disturbance rejection. Ind. Eng. Chem. Res. 2002, 41, 4807-4822, Rivera, D. E.; Morari, M.; Skogestad, S. Internal model control. 4. PID controller design, Ind. Eng. Chem. Res. 1986, 25, 252-265, Skogestad, S. Simple analytic rules for model reduction and PID controller tuning, J. Process Control, 2003, 13, 291-309, Shamsuzzoha, M.; Lee, M. IMC-PID controller design for improved disturbance rejection, Ind. Eng. Chem. Res. 2007, 46, 2077-2091, Shamsuzzoha, M.; Lee, M. Design of advanced PID controller for enhanced disturbance rejection of second order process with time delay. AIChE, 2008, 54, 1526-1536, Ziegler, J. G.; Nichols, N. B. Optimum settings for automatic controllers. Trans. ASME, 1942, 64, 759-768, Åström, K. J.; Hägglund, T. Automatic tuning of simple regulators with specifications on phase and amplitude margins. Automatica, 1984, 20, 645-651, Tyreus, B. D.; Luyben, W. L. Tuning PI controllers for integrator/dead time processes, Ind. Eng. Chem. Res. 1992, 2625-2628, Schei, T. S. A method for closed-loop automatic tuning of PID controllers. Automatica, 1992, 20, 587-591, Luyben, W. L. Getting more information from Relay-Feedback tests, Ind. Eng. Chem. Res. 2001, 40, 4391-4402, Haugen, F. Comparing PI tuning methods in a real benchmark temperature control system. Modeling, Identification and Control, 2010, 31, 79-91, Hu, W.; Xiao, G. Analytical proportional-integral (PI) controller tuning using closed-loop setpoint response, Ind. Eng. Chem. Res. 2011, 50, 2461-2466, Yuwana, M.; Seborg, D. E. A new method for on-line controller tuning. AIChE, 1982, 28, 434-440, Veronesi, M.; Visioli, A. Performance assessment and retuning of PID controllers for integral processes. J. Process Control, 2010, 20, 261-269, Seki, H.; Shigemasa, T. Retuning oscillatory PID control loops based on plant operation data. J. Process Control, 2010, 20, 217-227, Luyben, W. L. Simple method for tuning SISO controllers in multivariable systems, Ind. Eng. Chem. Process Des. Dev. 1986, 25, 654-660, each incorporated herein by reference) and among those two are widely used for the controller tuning, one may use open-loop or closed-loop plant tests. Most tuning approaches are based on open-loop plant information; typically the plant's gain (k), time constant (τ) and time delay (θ).

One popular approach is direct synthesiss (see Seborg, D. E.; Edgar, T. F.; Mellichamp, D. A. Process Dynamics and Control, 2nd ed.; John Wiley & Sons, New York, 2004, incorporated herein by reference) and the direct synthesis for the disturbance (DS-d) method proposed by Chen and Seborg (Chen, D.; Seborg, D. E. PI/PID controller design based on direct synthesis and disturbance rejection. Ind. Eng. Chem. Res. 2002, 41, 4807-4822, incorporated herein by reference), in that they obtained the PI/PID controller parameters by computing the ideal feedback controller which gives a predefined desired closed-loop response.

The IMC based PI/PID tuning method has been proposed by Rivera et al (Rivera D. E.; Morari, M.; Skogestad, S. Internal model control. 4. PID controller design, Ind. Eng. Chem. Res. 1986, 25, 252-265, incorporated herein by reference), Skogestad (Skogestad, S. Simple analytic rules for model reduction and PID controller tuning, J. Process Control, 2003, 13, 291-309, incorporated herein by reference) and Shamsuzzoha and Lee (Shamsuzzoha, M.; Lee, M. IMC-PID controller design for improved disturbance rejection, Ind. Eng. Chem. Res. 2007, 46, 2077-2091, Shamsuzzoha, M.; Lee, M. Design of advanced PID controller for enhanced disturbance rejection of second order process with time delay. AIChE, 2008, 54, 1526-1536, each incorporated herein by reference) for different type of processes.

Although the ideal controller for both the approach are often more complicated than the PI/PID controller for time delayed processes, the controller form can be reduced to either a PI/PID controller or a PID controller cascaded with a low order filter by performing appropriate approximations of the dead time in the process model. The PI/PID tuning method based on both the approaches is simpler in use with significantly improved performance. It is well-known that the PID tuning based on both the methods give very good performance for setpoint changes but sluggish responses to input (load) disturbances for lag-dominant (including integrating) processes with θ/τ<0.125.

To improve load disturbance rejection, Skogestad (Skogestad, S. Simple analytic rules for model reduction and PID controller tuning, J. Process Control, 2003, 13, 291-309, incorporated herein by reference) proposed the modified SIMC method where the integral time is reduced for processes with a large value of the time constant τ. The SIMC rule has one tuning parameter similar to IMC, the closed-loop time constant τ_{c}, and for “fast and robust” control it is recommended to choose τ_{c}=θ, where θ is the (effective) time delay.

Shamsuzzoha and Lee (Shamsuzzoha, M.; Lee, M. Design of advanced PID controller for enhanced disturbance rejection of second order process with time delay. AIChE, 2008, 54, 1526-1536, incorporated herein by reference) developed the PID controllers in series with lead/lag compensators for stable, integrating and unstable processes. This method gives significantly better performance for different types of second order process.

However, these approaches require that one first obtains an open-loop model of the process and then tuning of the control-loop. There are two problems here. First, an open-loop experiment, for example a step test, is normally needed to get the required process data. This may be time consuming and may upset the process and even lead to process runaway. Second, approximations are involved in obtaining the process parameters (e.g., k, τ and θ) from the data.

The main alternative is to use closed-loop experiments. One approach is the classical method of Ziegler-Nichols (Ziegler, J. G.; Nichols, N. B. Optimum settings for automatic controllers. Trans. ASME, 1942, 64, 759-768, incorporated herein by reference) which requires very little information about the process; namely, the ultimate controller gain (Kᵤ) and the period of oscillations (Pᵤ) which are obtained from a single experiment. For a PI-controller the recommended settings are K_{c}=0.45Kᵤ and τ_{I}=0.83Pᵤ. However, there are several disadvantages. First, the system needs to be brought to its limit of instability and a number of trials may be needed to bring the system to this point. To avoid this problem one may induce sustained oscillation with an on-off controller using the relay method of Åström and Hägglund (Åström, K. J.; Hägglund, T. Automatic tuning of simple regulators with specifications on phase and amplitude margins. Automatica, 1984, 20, 645-651, incorporated herein by reference). However, this requires that the feature of switching to on/off-control has been installed in the system. Another disadvantage is that the Ziegler-Nichols Ziegler (J. G.; Nichols, N. B. Optimum settings for automatic controllers. Trans. ASME, 1942, 64, 759-768, incorporated herein by reference) tunings do not work well on all processes.

It is well known that the recommended settings are quite aggressive for lag-dominant (integrating) processes (Tyreus and Luyben, (see Tyreus, B. D.; Luyben, W. L. Tuning PI controllers for integrator/dead time processes, Ind. Eng. Chem. Res. 1992, 2625-2628, incorporated herein by reference) and quite slow for delay-dominant process (see Skogestad, S. Simple analytic rules for model reduction and PID controller tuning, J. Process Control, 2003, 13, 291-309).

To get better robustness for the lag-dominant (integrating) processes, Tyreus and Luyben (see Tyreus, B. D.; Luyben, W. L. Tuning PI controllers for integrator/dead time processes, Ind. Eng. Chem. Res. 1992, 2625-2628, incorporated herein by reference) proposed to use less aggressive settings (K_{c}=0.313Kᵤ and τ_{I}=2.2Pᵤ), but this makes the response even slower for delay-dominant processes (see Skogestad, S. Simple analytic rules for model reduction and PID controller tuning, J. Process Control, 2003, 13, 291-309, incorporated herein by reference). This is a fundamental problem of the Ziegler-Nichols (Ziegler, J. G.; Nichols, N. B. Optimum settings for automatic controllers. Trans. ASME, 1942, 64, 759-768, incorporated herein by reference) method because it uses only two pieces of information about the process (Kᵤ, Pᵤ), which correspond to the critical point on the Nyquist curve. This does allow one to distinguish, for example, between a lag-dominant and a delay-dominant process. A fix is to use additional closed-loop experiments, for example, an experiment with an integrating controller (Schei, T. S. A method for closed-loop automatic tuning of PID controllers. Automatica, 1992, 20, 587-591, incorporated herein by reference) and this does allow one to distinguish between a lag-dominant and a delay-dominant process. A third disadvantage of the Ziegler-Nichols (Ziegler, J. G.; Nichols, N. B. Optimum settings for automatic controllers. Trans. ASME, 1942, 64, 759-768, incorporated herein by reference) method is that it can only be used on processes for which the phase lag exceeds −180 degrees at high frequencies. For example, it does not work on a simple second-order process. Luyben (Luyben, W. L. Getting more information from Relay-Feedback tests, Ind. Eng. Chem. Res. 2001, 40, 4391-4402, incorporated herein by reference) proposed modified Relay-Feedback method for the identification of the process by using information of the shapes of the response curve. The method provides approximate model for the processes that can be described by a first-order lag with dead time. His method works on some higher-order systems, but it is not applicable for inverse-response and unstable processes.

Recently, Shamsuzzoha and Skogestad (see Shamsuzzoha, M.; Skogestad, S. The setpoint overshoot method: A simple and fast closed-loop approach for PID tuning. J. Process Control, 2010, 20, 1220-1234, incorporated herein by reference) have developed new procedure for PI/PID tuning method in closed-loop mode. Their method is based on the SIMC tuning rule and provides satisfactory result for both performance and robustness. For the PID tuning parameter they need to repeat the experiment with PD controller based on the prior information obtained from P controller test. They recommended to adding the derivative action only for dominant second-order process.

Haugen (Haugen, F. Comparing PI tuning methods in a real benchmark temperature control system. Modeling, Identification and Control, 2010, 31, 79-91, incorporated herein by reference) has developed “Good Gain method” in which he mentioned to find the suitable controller gain in closed-loop mode. Like in the “Setpoint Overshoot Method” (Shamsuzzoha, M.; Skogestad, S. The setpoint overshoot method: A simple and fast closed-loop approach for PID tuning. J. Process Control, 2010, 20, 1220-1234, incorporated herein by reference) the system is not brought into marginal stability during the tuning and that is the advantage of this method. Good Gain method has significant drawback, as the method may not be quick to use because of a number of trial used to find a good value of the controller gain and eventually suitable tuning parameters.

Dale's closed-loop PI tuning technique is mainly for industrial practitioner and it is based on the trial and error approach in which one should have controller gain (K_{cd}) in closed-loop for the critically damped output response. It is repetitive process to obtain the suitable controller gain (K_{cd}) for critically damped output response and then final controller gain is given based on desired response. The suggested final controller gains are K_{c}≈1.2K_{cd} and K_{c}≈0.8K_{cd} for desired underdamped and overdamped response respectively. Large integral time (τ_{I}) is recommended for the offset removal and if required derivative action can be added in the final setting.

Hu and Xiao (Hu, W.; Xiao, G. Analytical proportional-integral (PI) controller tuning using closed-loop setpoint response, Ind. Eng. Chem. Res. 2011, 50, 2461-2466, incorporated herein by reference) have tried to develop an analytical PI tuning method, which resembles “The setpoint overshoot method” (Shamsuzzoha, M.; Skogestad, S. The setpoint overshoot method: A simple and fast closed-loop approach for PID tuning. J. Process Control, 2010, 20, 1220-1234, incorporated herein by reference). They have derived an analytical PI-tuning rule for integral plus time delay (ITD) and first-order plus time delay (FOTD) processes using “The setpoint overshoot method” (Shamsuzzoha, M.; Skogestad, S. The setpoint overshoot method: A simple and fast closed-loop approach for PID tuning. J. Process Control, 2010, 20, 1220-1234, incorporated herein by reference). The rule expresses the PI parameters in terms of the steady-state offset, peak time, and overshoot or rise time, as recorded in a closed-loop experiment (Shamsuzzoha, M.; Skogestad, S. The setpoint overshoot method: A simple and fast closed-loop approach for PID tuning. J. Process Control, 2010, 20, 1220-1234, incorporated herein by reference). The rule turns out to be applicable to a broad range of processes typical for process control, and it gives comparable performance to the PI tuning rule proposed in the recent work of Shamsuzzoha and Skogestad (see Shamsuzzoha, M.; Skogestad, S. The setpoint overshoot method: A simple and fast closed-loop approach for PID tuning. J. Process Control, 2010, 20, 1220-1234, incorporated herein by reference).

Yuwana and Seborg (Yuwana, M.; Seborg, D. E. A new method for on-line controller tuning. AIChE, 1982, 28, 434-440, incorporated herein by reference) originally proposed a two-step tuning procedure based on closed-loop setpoint experiment with a P-controller (proportional-only controller). They identified a first-order with delay model by matching the closed-loop setpoint response with a standard oscillating second-order step response. They used first-order Pade approximation for the time delay term in the process. They identified first overshoot and undershoot and second overshoot from the setpoint response, but the method may be modified to not using the second overshoot, as in the present study. In next step for the controller setting they used the Ziegler-Nichols (Ziegler, J. G.; Nichols, N. B. Optimum settings for automatic controllers. Trans. ASME, 1942, 64, 759-768, incorporated herein by reference) tuning rules, which as mentioned earlier may give rather aggressive setting.

Veronesi and Visioli (Veronesi, M.; Visioli, A. Performance assessment and retuning of PID controllers for integral processes. J. Process Control, 2010, 20, 261-269, incorporated herein by reference) recently published another two-step approach, where the idea is to assess and possibly retune an existing PI controller. From a closed-loop setpoint or disturbance response using the existing PI controller, they identify a first-order with delay model and time constant and use this to assess the closed-loop performance. If the performance is worse that could be expected, then the controller is retuned, for example, using the SIMC method. In another paper, Seki and Shigemasa (Seki, H.; Shigemasa, T. Retuning oscillatory PID control loops based on plant operation data. J. Process Control, 2010, 20, 217-227, incorporated herein by reference) proposed to retune the controller based comparing closed-loop responses obtained with two different controller settings.

It is important to note that often it is difficult to carryout open-loop test, and there are always possibility that control variable may drift away and operator needs to intervene in order to prevent products qualities from off-specification. In case of closed-loop test, one can easily keep control on the process during experiment and reduces the effect of disturbance to process operation.

The PI/PID controller design method has been discussed extensively in the literature and it shows that most of the tuning method is based on the two steps procedure. First step is to find the process parameters (e.g., k, τ and θ) by using an open-loop or closed-loop test. Second step is to use suitable tuning method to obtain the PI/PID controller setting.

The design method, which gives the PI/PID controller setting in a simple and effective way has always been an important research issue for process engineers. Therefore, the present disclosure is focused on the design of the PI/PID controller to fulfill the various objectives:
Controller tuning should be in closed-loop mode.
The PI/PID tuning rule should be simple, analytically derived and applicable to different types of process with a wide range of process parameters in a unified framework.
The disclosed closed-loop tuning method should overcome the shortcoming of the Ziegler-Nichols continuous cycling method.
The method should be applicable to the wide range of the overshoot (approximately 10-60%) with the initial controller gain K_{c0}.

Therefore, the goal of the present disclosure is to find simple and direct controller tuning method with enhanced performance in closed-loop mode for the broad class of the processes.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

A new online controller tuning method in closed-loop mode improves over the Ziegler-Nichols continuous cycling method. The method is a closed-loop setpoint step experiment PI/PID controller tuning method, which uses a P-controller with a gain K_{c0}, runs a setpoint experiment, and obtains a plurality of PI/PID-controller settings directly from three data from the setpoint experiment, wherein the three data are overshoot (Δyₚ−Δy_{∞})/Δy_{∞}, time to reach overshoot or first peak tₚ, and relative steady state output change b=Δy_{∞}/Δyₛ, wherein Δyₛ=yₛ−y₀ is a setpoint change, Δy_{∞}=y_{∞}−y₀ is a steady-state output change after setpoint step test, and Δyₚ=yₚ−y₀ is a peak output change at time tₚ.

In one aspect the method of the present disclosure further speeds up the closed loop experiment to reach steady state, by estimating the steady-state output change after setpoint step test variable by multiply the sum of the two variables of setpoint change and peak output change by 0.45.

Δy_{∞}=0.45(Δyₚ+Δyᵤ)

where Δyₚ is first peak output change and Δyᵤ first minimum of the process output.

In another aspect, the method of the present disclosure is further applied to a 30 tray distillation column temperature control loop with the depropanizer column, fed at tray 15, producing a distillate product that is 98 mole % propane, with the vapor pressure of propane being slightly higher than 200 psia at 110° F., the liquid density of hydrocarbon system being about 30 lb/ft³, the reboiler pressure being 202.6 psia, the design reflux ratio being 3.22, the design reboiler heat input being 1.02×10⁶ Btu/hr, the specified purity of distillate being 98 mol % propane, the specified impurity of propane being 1.0 mol %, and the boiler pressure being estimated by assuming a pressure drop over each tray of 5 inches of liquid in the high-pressure column (see W. L. Luyben, Plantwide Dynamic Simulators in Chemical Processing and Control, New York: Marcel Dekker, Inc., 2002., incorporated herein by reference).

In another aspect the present disclosure requires no detail prior information of the plant (process parameters k, θ and τ) to obtain the robust controller setting from the closed-loop setpoint experiment.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 shows the block diagram of feedback control system;

FIG. 2 shows the closed-loop step setpoint response with P-only control;

FIG. 3 shows step setpoint responses with various overshoots for first-order plus time delay process, g=e^{-s}/(10 s+1);

FIG. 4 shows step setpoint responses with overshoot of 0.3 (30%) for eight first-order plus time delay processes with τ/θ ranging from 0 to 100 (g=e^{-θs}/(τs+1), θ=1);

FIG. 5 shows relationship between P-controller gain kK_{c0} used in setpoint experiment and corresponding IMC-PID controller gain kK_{c} in Eq. (11a);

FIG. 6 shows variation of A with overshoot using data (slopes) from FIG. 5;

FIG. 7 shows ratio of process time delay (θ) and setpoint overshoot time (tₚ) as a function of overshoot for four first-order with delay processes (solid lines). Dotted lines: Values of θ/tₚ used in final correlations;

FIG. 8 shows responses of simple second-order process

$$\frac{1}{( s + 1 ) ( 0.2 s + 1 )} . \qquad ( E1 )$$

Setpoint change at t=0; load disturbance of magnitude 1 at t=5;

FIG. 9 shows responses of high-order process

$$\frac{1}{( s + 1 ) ( 0.2 s + 1 ) ( 0.04 s + 1 ) ( 0.008 s + 1 )} , \qquad ( E5 )$$

Setpoint change at t=0; load disturbance of magnitude 1 at t=10;

FIG. 10 shows responses of third-order integrating process

$$\frac{1}{{s ( s + 1 )}^{2}} , \qquad ( E8 )$$

Setpoint change at t=0; load disturbance of magnitude 1 at t=100;

FIG. 11 shows responses of second-order with positive zero and time delay process

$$\frac{( - s + 1 ) {e}^{- s}}{( 6 s + 1 ) {( 2 s + 1 )}^{2}} , \qquad ( E11 )$$

Setpoint change at t=0; load disturbance of magnitude 1 at t=100;

FIG. 12 shows responses of first-order with time delay process

$$\frac{{e}^{- s}}{( 5 s + 1 )} , \qquad ( E17 )$$

Setpoint change at t=0; load disturbance of magnitude 1 at t=40;

FIG. 13 shows responses of pure time delay process e^{-s} (E21), Setpoint change at t=0; load disturbance of magnitude 1 at t=15;

FIG. 14 shows responses of integrating process with time delay

$$\frac{{e}^{- s}}{s} , \qquad ( E24 )$$

Setpoint change at t=0; load disturbance of magnitude 1 at t=50;

FIG. 15 shows responses of first-order unstable process

$$g = \frac{{e}^{- s}}{5 s - 1} , \qquad ( E33 )$$

Setpoint change at t=0; load disturbance of magnitude 1 at t=40;

FIG. 16 shows MV plots of E5, Setpoint change at t=0; load disturbance of magnitude 1 at t=10;

FIG. 17 shows MV plots of E8, Setpoint change at t=0; load disturbance of magnitude 1 at t=100;

FIG. 18 shows MV plots of E17, Setpoint change at t=0; load disturbance of magnitude 1 at t=40;

FIG. 19 shows responses of first-order with time delay process

$$\frac{{e}^{- 0.1 s}}{( s + 1 )} ,$$

Setpoint change at t=0; load disturbance of magnitude 1 at t=2;

FIG. 20 shows responses of first-order with time delay process

$$\frac{{e}^{- s}}{( s + 1 )} ,$$

Setpoint change at t=0; load disturbance of magnitude 1 at t=10;

FIG. 21 shows responses of first-order with time delay process

$$\frac{{e}^{- 10 s}}{( s + 1 )} ,$$

Setpoint change at t=0; load disturbance of magnitude 1 at t=60;

FIG. 22 shows effect of detuning factor: Responses of first order process with time delay

$$\frac{{e}^{- s}}{( s + 1 )} , \qquad ( E18 )$$

Setpoint change at t=0; load disturbance of magnitude 1 at t=20;

FIG. 23 shows responses of first-order with time delay process

$$\frac{{e}^{- s}}{( 5 s + 1 )} , \qquad ( E17 )$$

Setpoint change at t=0; load disturbance of magnitude 1 at t=40;

FIG. 24 shows responses of the first-order with time delay process (approximately integrating process with time delay)

$$\frac{100 {e}^{- s}}{100 s + 1} , \qquad ( E22 )$$

Setpoint change at t=0, load disturbance of magnitude 1 at t=50;

FIG. 25 shows responses of second-order with positive zero and time delay process

$$\frac{( - s + 1 ) {e}^{- s}}{( 6 s + 1 ) {( 2 s + 1 )}^{2}} , \qquad ( E11 )$$

Setpoint change at t=0; load disturbance of magnitude 1 at t=100; and

FIG. 26 shows a computer system upon which an embodiment of the present invention may be implemented.

### DETAILED DESCRIPTION

The description provided here is intended to enable any person skilled in the art to understand, make and use this invention. Various modifications to the disclosed embodiments will be readily apparent to those skilled in the art, and the general principals defined herein may be applied to these modified embodiments and applications without departing from the scope of this invention. In each of the embodiment, the various actions could be performed by program instruction running on one or more processors, by specialized circuitry or by a combination of both. Moreover, the invention can additionally be considered to be embodied, entirely or partially, within any form of computer readable carrier containing instructions that will cause the executing device to carry out the technique disclosed herein. The present invention is thus, not intended to be limited to the disclosed embodiments, rather it is be accorded the widest scope consistent with the principles and features disclosed herein.

Details of functions and configurations well known to a person skilled in this art are omitted to make the description of the present invention clear. The same drawing reference numerals will be understood to refer to the same elements throughout the drawings.

Although the description and discussion were in reference to certain exemplary embodiments of the present disclosure, numerous additions, modifications and variations will be readily apparent to those skilled in the art. The scope of the invention is given by the following claims, rather than the preceding description, and all additions, modifications, variations and equivalents that fall within the range of the stated claims are intended to be embraced therein.

IMC-PID Controller Tuning Rule

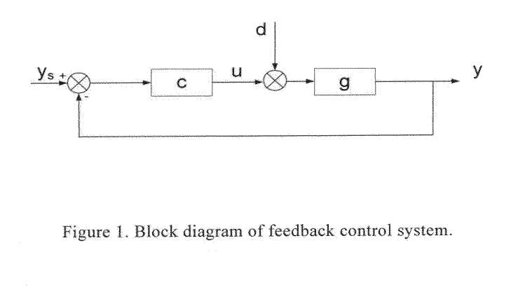

In FIG. 1, the block diagram of a conventional feedback control system is shown, where g denotes the process transfer function and c the feedback controller (see for example the concept of the IMC-PID (Seborg, D. E.; Edgar, T. F.; Mellichamp, D. A. Process Dynamics and Control, 2nd ed.; John Wiley & Sons, New York, 2004, incorporated herein by reference) controller tuning for first order process with time delay). The other variables are the manipulated variable u, the measured and controlled output variable y, the setpoint yₛ, and the disturbance d, which is assumed to be a “load disturbance” at the plant input. The closed-loop transfer functions from the setpoint and load disturbance to the output are:

$$y = \frac{cg}{1 + cg} {y}_{s} + \frac{g}{1 + cg} d \qquad ( 1 )$$

In process control, a first-order process with time delay is a common representation of the process dynamics:

$$g ( s ) = \frac{k {e}^{- {θ}_{s}}}{τ s + 1} \qquad ( 2 )$$

k is the process gain, τ lag time constant and θ the time delay. Most processes in the chemical industries can be satisfactorily controlled using a PID controller:

$$c ( s ) = {K}_{c} ( 1 + \frac{1}{{τ}_{l} s} + {τ}_{D} s ) \qquad ( 3 )$$

The other structure of the PID controller like series form of the PID can easily be transform from Eq. (3) (Seborg, D. E.; Edgar, T. F.; Mellichamp, D. A. Process Dynamics and Control, 2nd ed.; John Wiley & Sons, New York, 2004, incorporated herein by reference). The following relation can express the conventional feedback controller, which is equivalent to the IMC controller.

$$c ( s ) = \frac{q}{1 - \tilde{g} q} \qquad ( 4 )$$

where \tilde{g} denotes the process transfer function, c and q are the conventional controller and IMC controller, respectively. The IMC controller is designed in two steps (details are available in Seborg, D. E.; Edgar, T. F.; Mellichamp, D. A. Process Dynamics and Control, 2nd ed.; John Wiley & Sons, New York, 2004, incorporated herein by reference):

Step 1: The process model \tilde{g} is decomposed into two parts:

\tilde{g}=p_{M}p_{A} (5)

where p_{M} and p_{A} are the portions of the model inverted and not inverted, respectively, by the controller (p_{A} is usually a non-minimum phase and contains dead times and/or right half plane zeros); p_{A}(0)=1.

Step 2: The IMC controller is designed by

q=p_{M}⁻¹f (6)

The IMC filter f is usually given as f=1/(τ_{c}s+1)^{r} where τ_{c} is an adjustable parameter that controls the tradeoff between the performance and robustness; r is selected to be large enough to make the IMC controller semi-proper. The first order Pade approximation has been utilize for the approximation of the dead time term in Eq. (2).

$$g ( s ) = \frac{k ( 1 - \frac{θ}{2} s )}{( τ s + 1 ) ( 1 + \frac{θ}{2} s )} \qquad ( 7 )$$

The resulting IMC-PID tuning formula (Seborg, D. E.; Edgar, T. F.; Mellichamp, D. A. Process Dynamics and Control, 2nd ed.; John Wiley & Sons, New York, 2004, incorporated herein by reference) after simplification is obtain in Eq. (8) for the first order process with time delay in Eq. (2).

$$\begin{matrix}{K}_{c} = \frac{2 τ + θ}{k ( 2 {τ}_{c} + θ )} & ( 8 a ) \\ {τ}_{I} = τ + \frac{θ}{2} & ( 8 b ) \\ {τ}_{D} = \frac{τ θ}{2 τ + θ} & ( 8 c )\end{matrix}$$

The IMC-PID controller designed based on the IMC principle provides excellent set point tracking, but has a sluggish disturbance response, especially for processes with a small θ/τ ratio (Shamsuzzoha, M.; Skogestad, S. The setpoint overshoot method: A simple and fast closed-loop approach for PID tuning. J. Process Control, 2010, 20, 1220-1234, Seborg, D. E.; Edgar, T. F.; Mellichamp, D. A. Process Dynamics and Control, 2nd ed.; John Wiley & Sons, New York, 2004, Chen, D.; Seborg, D. E. PI/PID controller design based on direct synthesis and disturbance rejection. Ind. Eng. Chem. Res. 2002, 41, 4807-4822, Rivera, D. E.; Moran, M.; Skogestad, S. Internal model control. 4. PID controller design, Ind. Eng. Chem. Res. 1986, 25, 252-265, Skogestad, S. Simple analytic rules for model reduction and PID controller tuning, J. Process Control, 2003, 13, 291-309, Shamsuzzoha, M.; Lee, M. IMC-PID controller design for improved disturbance rejection, Ind. Eng. Chem. Res. 2007, 46, 2077-2091, each incorporated herein by reference).

To improve the load disturbance response Skogestad (Skogestad, S. Simple analytic rules for model reduction and PID controller tuning, J. Process Control, 2003, 13, 291-309, incorporated herein by reference) recommended to modify the integral time as

τ_{I}=4(τ_{c}+θ) (9)

In the disclosed method, the objective is to obtain the improved disturbance rejection response. Therefore, the integral time in Eq. (8b) is modified similar to SIMC (Skogestad, S. Simple analytic rules for model reduction and PID controller tuning, J. Process Control, 2003, 13, 291-309, incorporated herein by reference) for the improved disturbance and given as:

$${τ}_{I} = min \{ ( τ + \frac{θ}{2} ) , 4 ( {τ}_{c} + θ ) \} \qquad ( 10 )$$

τ_{c}=θ is recommend setting for this tuning rule which gives maximum sensitivity (Mₛ)=1.70, approximately. The resulting simplified tuning rule for the PID controller setting after τ_{c}=θ is given as:

$$\begin{matrix}{K}_{c} = \frac{2 τ + θ}{3 k θ} & ( 11 a ) \\ {τ}_{I} = min \{ ( τ + \frac{θ}{2} ) , 8 θ \} & ( 11 b ) \\ {τ}_{D} = \frac{τ θ}{2 τ + θ} & ( 11 c )\end{matrix}$$

Closed-Loop Experiment

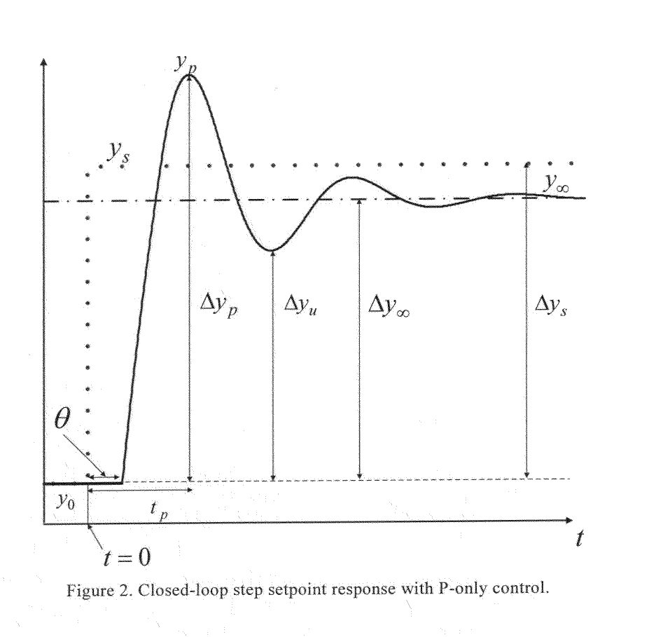

Development of a PI/PID controller based on the closed-loop data which resembles the PID tuning method in Eq. (11). The simplest closed-loop experiment is probably a setpoint step test (FIG. 2) where one maintains full control of the process, including the change in the output variable. The simplest to observe is the time tₚ to reach the (first) overshoot and its magnitude, and this information is therefore the basis for the disclosed method.

The disclosed procedure is as follows (Shamsuzzoha, M.; Skogestad, S. The setpoint overshoot method: A simple and fast closed-loop approach for PID tuning. J. Process Control, 2010, 20, 1220-1234, incorporated herein by reference):

1. Switch the controller to P-only mode (for example, increase the integral time τ_{I} to its maximum value or set the integral gain K_{I} to zero). In an industrial system, with bumpless transfer, the switch should not upset the process.

2. Make a setpoint change that gives an overshoot between 0.10 (10%) and 0.60 (60%); about 0.30 (30%) is a good value. Record the controller gain K_{c0} used in the experiment. Most likely, unless the original controller was quite tightly tuned, one will need to increase the controller gain to get a sufficiently large overshoot.

Note that small overshoots (less than 0.10) are not considered because it is difficult in practice to obtain from experimental data accurate values of the overshoot and peak time if the overshoot is too small. Also, large overshoots (larger than about 0.6) give a long settling time and require more excessive input changes. For these reasons the present disclosure uses an “intermediate” overshoot of about 0.3 (30%) for the closed-loop setpoint experiment.

3. From the closed-loop setpoint response experiment, one can obtain the following values (see FIG. 2):
Controller gain, K_{c0}
Overshoot=(Δyₚ−Δy_{∞})/Δy_{∞}
Time from setpoint change to reach peak output (overshoot), tₚ
Relative steady state output change, b=Δy_{∞}/Δyₛ.

Here the output variable changes are:

Δyₛ=yₛ−y₀: Setpoint change

Δyₚ=yₚ−y₀: Peak output change (at time tₚ)

Δy_{∞}=y_{∞}−y₀: Steady-state output change after setpoint step test

To find Δy_{∞} one needs to wait for the response to settle, which may take some time if the overshoot is relatively large (typically, 0.3 or larger). In such cases, one may stop the experiment when the setpoint response reaches its first minimum and record the corresponding output, Δyᵤ, (Shamsuzzoha and Skogestad (see Shamsuzzoha, M.; Skogestad, S. The setpoint overshoot method: A simple and fast closed-loop approach for PID tuning. J. Process Control, 2010, 20, 1220-1234, incorporated herein by reference).

Δy_{∞}=0.45(Δyₚ+Δyᵤ) (12)

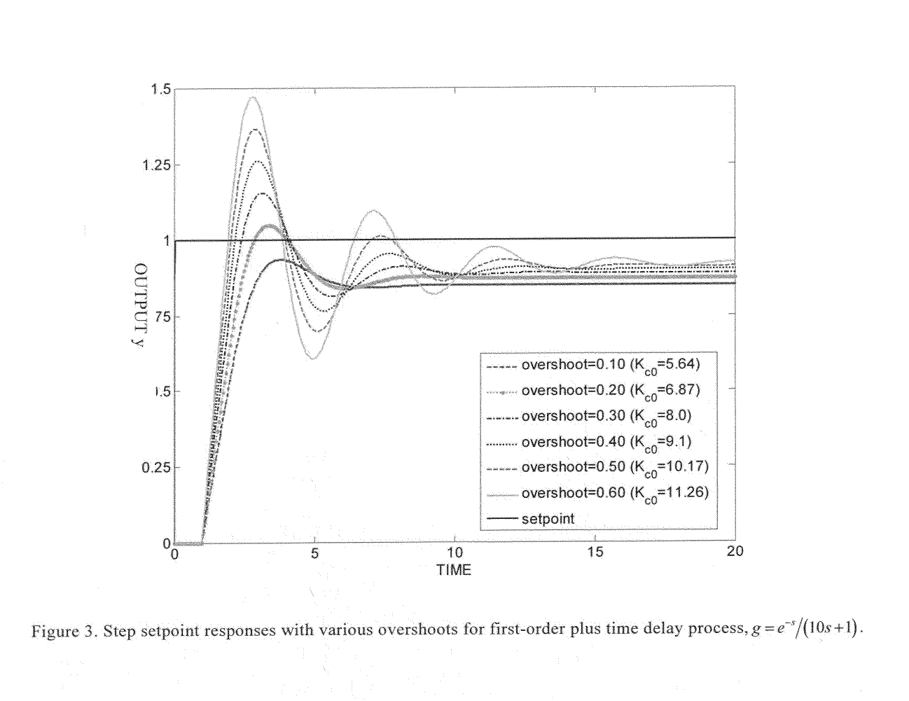

To make the disclosed setpoint experiment more understandable, simulation has been conducted for six different controller gains K_{c0}. The resulting closed-loop response is shown in FIG. 3, which gives the overshoots of 0.10, 0.20, 0.30, 0.40, 0.50 and 0.60. A typical process g(s)=e^{-s}/(10 s+1) is considered for this analysis which has a unit time delay (θ=1) and has ten times larger time constant (τ=10). As expected, the closed-loop response gets faster and more oscillatory as the overshoot increases. As mentioned earlier the recommended intermediate overshoot of about 0.3 (30%) is the best choice for the closed-loop setpoint experiment.

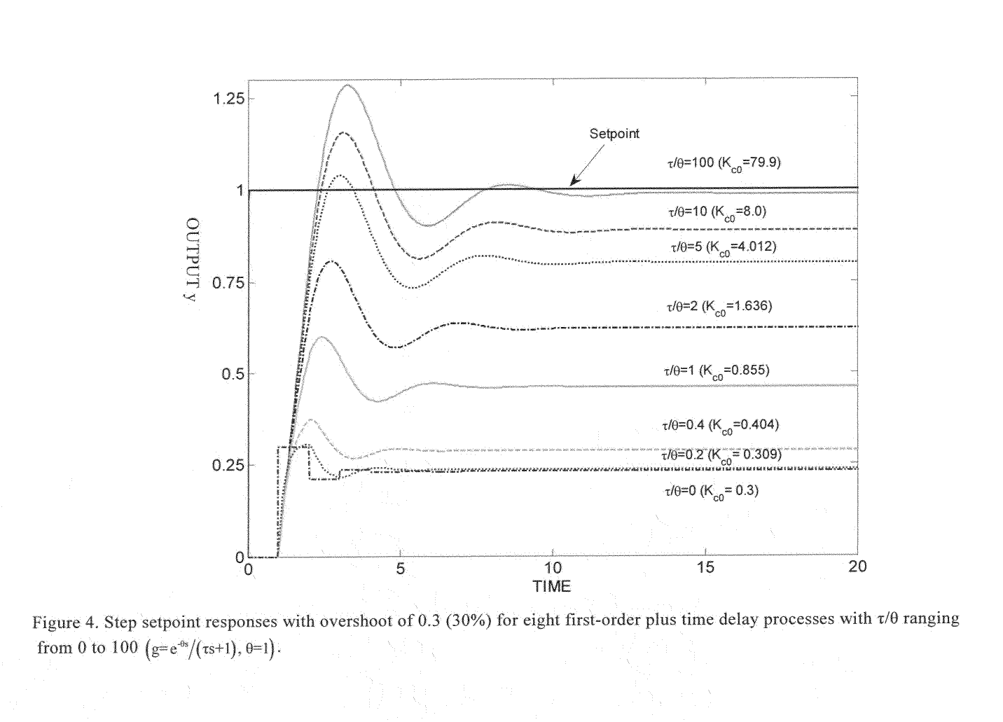

FIG. 4 shows setpoint responses when the P-controller gain K_{c0} has been adjusted to give an overshoot of 0.3 for a wide range of first-order plus delay processes with a unit time delay (θ=1), g(s)=e^{-s}/(τs+1). The process time constant τ varies from 0 (pure delay process) to 100 (almost integrating process). The time to reach the first peak (tₚ) increases somewhat as T increases, but the most striking difference is that the steady-state output change (b-value) approaches 1 as τ increase. Thus, the b-value provides an indirect measure of the value of τ/θ, which will be utilize in the next section.

Correlation Between Closed-Loop Setpoint Response and the PID Settings

A procedure in closed-loop for controller tuning to derive a correlation, preferably as simple as possible, between the setpoint response data (FIG. 2) and the PID settings in Eq. (11), initially with the choice τ_{c}=θ. For this purpose, consider 15 first-order with delay models g(s)=ke^{-θs}/(τs+1) that cover a wide range of processes; from delay-dominant to lag-dominant (integrating):

τ/θ=0.1, 0.2, 0.4, 0.8, 1.0, 1.5, 2.0, 2.5, 3.0, 7.5, 10.0, 20.0, 50.0, 100.0

It is always possible to scale time with respect to the time delay (θ) and since the closed-loop response depends on the product of the process and controller gains (kK_{c}), so without loss of generality k=1 and θ=1, were used in all simulations.

For each of 15 process models (values of τ/θ), the PID settings was obtained using Eq. (11) with the choice τ_{c}=0. Furthermore, for each of 15 processes 6 closed-loop step setpoint responses were generated using P-controllers that give different fractional overshoots.

Overshoot=0.10, 0.20, 0.30, 0.40, 0.50 and 0.60

In total, it has then 90 setpoint responses, and for each of these four data were recorded:

The P-controller gain K_{c0} is used in the experiment, the fractional overshoot, the time to reach the overshoot (tₚ), and the relative steady-state change, b=Δy_{∞}/Δyₛ.

Controller Gain (K_{c}).

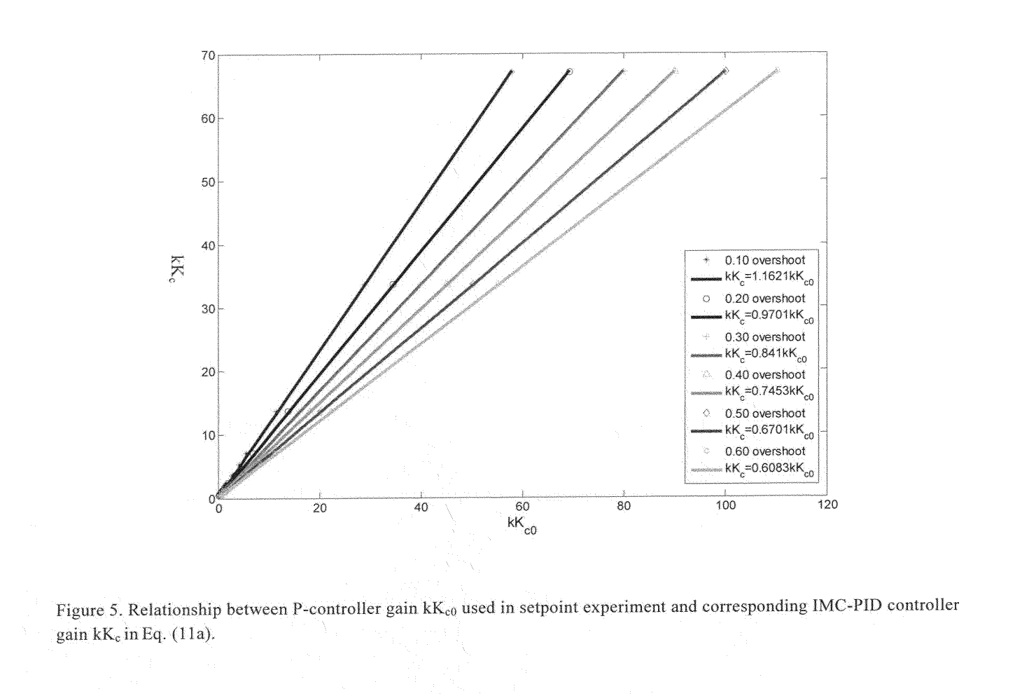

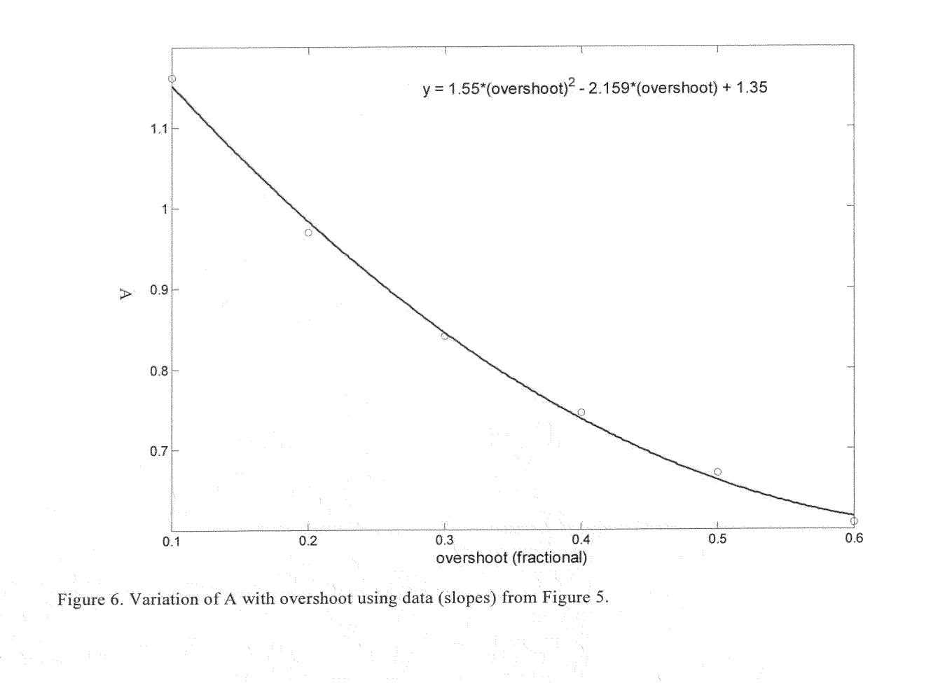

Initially the aim is to obtain a relationship between the above four data and the corresponding disclosed controller gain K_{c}. Indeed, as illustrated in FIG. 5, where kK_{c} was plotted as a function of kK_{c0} for 90 setpoint experiments, the ratio K_{c}/K_{c0} is approximately constant for a fixed value of the overshoot, independent of the value of τ/θ. Thus, it is possible to write

$$\frac{{K}_{c}}{{K}_{c 0 }} = A \qquad ( 13 )$$

where the ratio A is a function of the overshoot only. In FIG. 6, the plot of the value of A as a function of the overshoot is given, which is obtained as the best fit of the slopes of the lines in FIG. 5. The following equation (solid line in FIG. 6) fits the data in FIG. 5 well and is given as:

A=[1.55 (overshoot)²−2.159 (overshoot)+1.35] (14)

Conclusion:

The controller gain (K_{c}) from the closed-loop step test is obtained from the following final Eq. (15). It is only function of initial controller gain (K_{c0})) and overshoot.

K_{c}=K_{c0}[1.55 (overshoot)²−2.159 (overshoot)+1.351] (15)

Integral time (τ_{I}):

It is interesting to find a simple correlation for the integral time. The PID method in Eq. (11b) uses the minimum of two values for the integral time. Therefore, it is reasonable to search a similar relationship, that is, to find one value (τ_{I1}=τ+θ/2) for processes with a relatively large delay, and another value (τ_{I2}=8θ) for processes with a relatively small delay including integrating processes.

Case I: (Process with Relatively Large Delay):

This case arise when processes have a relatively large delay i.e., τ/θ<8, the integral action in the disclosed tuning rule is to use τ_{I}=(τ+θ/2). Rearrangement of Eq. (11a) is given as

$$τ = \frac{3 {kK}_{c} θ - θ}{2} \qquad ( 16 )$$

Adding both the side θ/2 in Eq. (16) and substitute (τ+θ/2)=τ_{I}, the resulting equation is

τ_{I}=1.5kK_{c}θ (17)

In Eq. (17), it is also required to balance the value of the process gain k, and to this effect write

kK_{c}=kK_{c0}·K_{c}/K_{c0} (18)

Here, the value of the loop gain kK_{c0} for the P-control setpoint experiment is given from the value of b:

$${kK}_{c 0} = \vert \frac{b}{( 1 - b )} \vert \qquad ( 19 )$$

Substituting kK_{c} from Eq. (18) and K_{c}/K_{c0}=A into Eq. (17), it is given as

$${τ}_{I} = 1.5 A \vert \frac{b}{( 1 - b )} \vert θ \qquad ( 20 )$$

To prove this, the closed-loop setpoint response is Δy/Δyₛ=gc/(1+gc) and a P-controller with gain K_{c0}, the steady-state value is Δy_{∞}/Δyₛ=kK_{c0}/(1+kK_{c0})=b. The absolute value is included to avoid the problems if b>1, as may occur for an unstable process or because of inaccurate data.

It is possible to obtain the value of time delay θ directly from the closed-loop setpoint response, but usually this is not always easy task. The reasonable correlation has been developed by Shamsuzzoha and Skogestad (Shamsuzzoha, M.; Skogestad, S. The setpoint overshoot method: A simple and fast closed-loop approach for PID tuning. J. Process Control, 2010, 20, 1220-1234, incorporated herein by reference) for the θ and the setpoint peak time tₚ which is easier to observe.

For processes with a relatively large time delay (τ/θ<8), the ratio θ/tₚ varies between 0.27 (for τ/θ=8 with overshoot=0.1) and 0.5 (for τ/θ=0.1 with all overshoots). For the intermediate overshoot of 0.3, the ratio θ/tₚ varies between 0.32 and 0.50. A conservative choice would be to use θ=0.5 tₚ because a large value increases the integral time. However, to improve performance for processes with smaller time delays, it is reasonable to use θ=0.43 tₚ which is only 14% lower than 0.50 (the worst case).

In summary, the integral time (τ_{I}) for process with a relatively large time delay:

$${τ}_{I} = 0.645 A \vert \frac{b}{( 1 - b )} \vert {t}_{p} \qquad ( 21 )$$

Case II: (Process with Relatively Small Delay):

The tuning rule has integral action for the lag-dominant process. The integral time for a lag-dominant (including integrating) process with τ/θ>8, the recommended tuning rule has integral time

τ_{I2}=8θ (22)

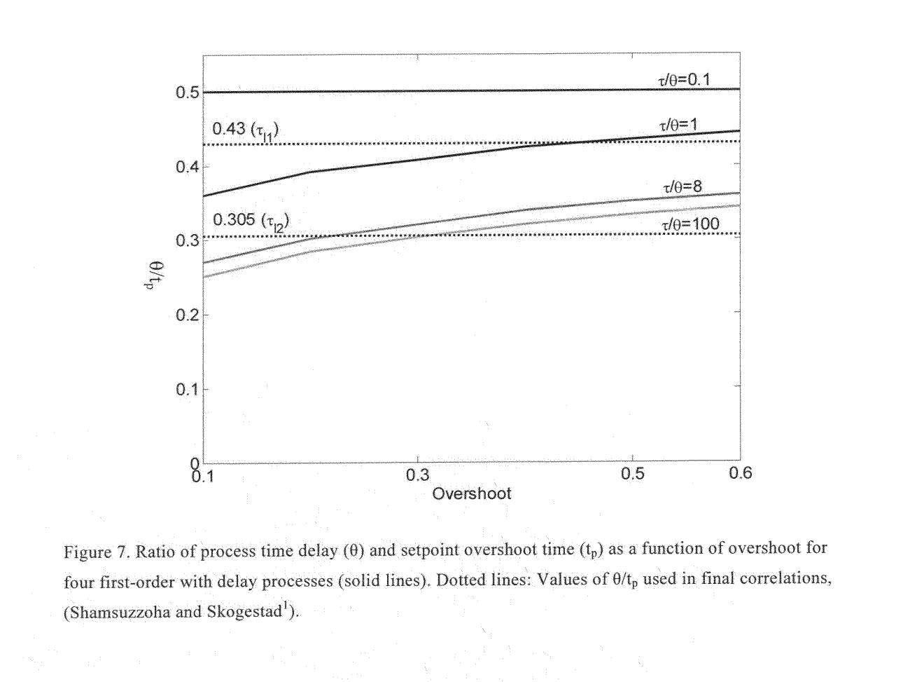

For τ/θ>8, FIG. 7 shows that the ratio θ/tₚ varies between 0.25 (for τ/θ=100 with overshoot=0.1) and 0.36 (for τ/θ=8 with overshoot 0.6). It is reasonable to select the average value θ=0.305 tₚ which is only 15% lower than 0.36 (the worst case). Also note that for the intermediate overshoot of 0.3, the ratio θ/tₚ varies between 0.30 and 0.32. In summary, the integral time for a lag-dominant process is

τ_{I2}=2.44tₚ (23)

Therefore, the integral time τ_{I} is obtained as the minimum of the above two values as recommended in Eq. (11-b):

$${τ}_{I} = min ( 0.645 A \vert \frac{b}{( 1 - b )} \vert {t}_{p} , 2.44 {t}_{p} ) \qquad ( 24 )$$

Derivative Time (τ_{D}):

Although a significant number of the PID controllers switched off their derivative part but proper use of derivative action can increase stability and improve the closed-loop performance. The derivative action is very important for slow moving loops where overshoot is undesirable e.g., temperature loop. The motivation of this section is to develop the approach for inclusion of the derivative action from closed-loop data. In the present disclosure the derivative action is recommended for the process having τ/θ≧1. The addition of the derivation action in that kind of slow process could be useful for the performance and stability improvement.

Substitute the value of τ=τ_{I}−0.50 into τ/θ≧1, and after rearrangement the resulting equation is given as

$$\frac{( {τ}_{I} - 0.5 θ )}{θ} \geq 1 \qquad ( 25 )$$

After simplification it is τ_{I}/θ≧1.5 and resulting constrain is kK_{c}≧1.0. The corresponding closed-loop condition for the derivative action is given as:

$$A \vert \frac{b}{( 1 - b )} \vert \geq 1 \qquad ( 26 )$$

Case I:

For approximately integrating process (τ>>θ), where integral time is τ_{I}=8θ. In the closed-loop the time delay and tₚ relation is θ=0.305 tₚ. The derivative time τ_{D1} in Eq. (11c) can be approximated as

$${τ}_{D 1} = \frac{τθ}{2 τ + θ} \approx \frac{τθ}{2 τ} = \frac{θ}{2} = \frac{0.305 {t}_{p}}{2} = 0.15 {t}_{p} \qquad ( 27 )$$

Case II:

The process with a relatively large delay, for this case integral time τ_{I}=(τ+0.5θ) and time delay in closed-loop is θ=0.43 tₚ. For such cases, the derivative action is recommended only if τ/θ≧1. Assuming the case when τ=θ, the τ_{D2} is given from Eq. (11c) as

$${τ}_{D 2} = \frac{τθ}{2 τ + θ} \approx \frac{{θ}^{2}}{2 θ + θ} = \frac{{θ}^{2}}{3 θ} = \frac{θ}{3} = \frac{0.43 {t}_{p}}{3} = 0.1433 {t}_{p} \qquad ( 28 )$$

Note: The derivative action is only recommended for the processes which have τ/θ≧1. The resulting criteria in the closed-loop to add derivative action is

$$A \vert \frac{b}{( 1 - b )} \vert \geq 1. \qquad$$

The derivative action for both the cases i.e., τ_{D1} and τ_{D2} are approximately same and the conservative choice for the selection of τ_{D} is recommended as

$${τ}_{D} = 0.14 {t}_{p} if A \vert \frac{b}{( 1 - b )} \vert \geq 1 \qquad ( 29 )$$

Selection of Proportional Controller Gain (K_{c0})

It is mentioned earlier that the disclosed method is valid for the overshoot between 0.1 to 0.6 however, an overshoot of around 0.3 is recommended for a better response. Sometimes achieving the P-controller gain (K_{c0}) via trial and error that gives the overshoot around 0.3 can be time consuming.

Therefore, an effective approach to get the value of K_{c0} that gives the overshoot around 0.3 is very significant for the disclosed method. It is important to note that this procedure requires initial information of the first closed-loop experiment. Let us assume that the first closed-loop test has P-controller gain of K_{c01} and resulting overshoot OS₁ is achieved that is between 0.1 to 0.60. It is not close to recommended value of overshoot 0.30.

Let the target overshoot be OS and the target P-controller gain be K_{c0}. In the disclosed closed-loop tuning method the goal is to match the performance with the PID tuning rule. This may be achieved only by maintaining a constant proportional gain K_{c}, regardless of the overshoot that resulted from the closed-loop setpoint test. Ideally, K_{c} should be the same as that determined with different overshoots from various closed-loop setpoint tests and the resulting correlation is given as:

[1.55 (OS₁)²−2.159(OS₁)+1.35]K_{c01}=[1.55(OS)²−2.159(OS)+1.35]K_{c0} (30)

The above Eq. (30) gives a general guideline for choosing the P-controller gain for the next closed-loop setpoint test. As it is mentioned earlier, the disclosed method is in good agreement with the PID setting for the overshoot around 0.3. Therefore, the overshoot in Eq. (30) is set as 0.30, and after simplification the gain for the next closed-loop test is recommended as:

K_{c0}=1.19(1.55(OS₁)²−2.159(OS₁)+1.35)K_{c01} (31)

Note: It is not so important to achieve the precise fractional overshoot of 0.3, so few trial is sufficient to get the desire overshoot around 0.3 from above Eq. (31).

A high order process given in Example E2 is considered to show the effectiveness of the disclosed Eq. (31) for the calculation of the desired overshoot in the step test experiment. First trial: Let us suppose P-controller is applied with initial controller gain K_{c01}=0.85, and after step test the resulting overshoot comes out to be OS₁=0.13. From Eq. (31), resulting controller gain for the next trial would be 1.042. Second trial: similar to first trial, use controller gain of 1.042 in second test and resulting overshoot would be 0.18. Based upon these two new information the controller gain would be 1.182, and corresponding to this controller gain the overshoot will be 0.22.

Final Choice of the Controller Settings (Detuning)

The disclosed method has been derived to match the performance with the PID tuning rule in Eq. (11). It is based on the closed-loop time constant equal to the time delay (τ_{c}=θ). In real practice one may want to use less aggressive (detuned) settings (τ_{c}>θ), or one may even want to speed up the response (τ_{c}<θ). To this end, a detuning factor F, where F>1 corresponds less aggressive settings and F<1 to more aggressive settings can be introduced (Shamsuzzoha, M.; Skogestad, S. The setpoint overshoot method: A simple and fast closed-loop approach for PID tuning. J. Process Control, 2010, 20, 1220-1234, Luyben, W. L. Simple method for tuning SISO controllers in multivariable systems, Ind. Eng. Chem. Process Des. Dev. 1986, 25, 654-660, each incorporated herein by reference).

The detuning factor F has been included in the controller gain and integral time and in conclusion, the final tuning formulas for the disclosed method are:

$$\begin{matrix}{K}_{c} = {K}_{c 0} A \text{/} F & ( 32 ) \\ {τ}_{I} = min ( 0.645 A \vert \frac{b}{( 1 - b )} \vert {t}_{p} F , 2.44 {t}_{p} F ) & ( 33 ) \\ {τ}_{D} = 0.14 {t}_{p} if A \vert \frac{b}{( 1 - b )} \vert \geq 1 & ( 34 )\end{matrix}$$

where A=[1.55 (overshoot)²−2.159 (overshoot)+1.35] and F is a detuning parameter. F=1 gives the “fast and robust” PI/PID settings corresponding to τ_{c}=θ. To detune the response and get more robustness one can selects F>1, but in special cases one may select F<1 to speed up the closed-loop response.

Simulation Study

A simulation study conducted on the different types of representative classes of process. The closed-loop simulations have been conducted for 33 different processes and the disclosed tuning method provides in all cases acceptable controller settings with respect to both performance and robustness. Several performance and robustness measure have been calculated for all 33 processes and listed in Table 1. The brief overview of the performance and robustness measure is mentioned here.

(1) Output performance (y) is quantified by computing the integrated absolute error,

$$I A E = {\int }_{0}^{∞} \vert y - {y}_{s} \vert d t .$$

Manipulated variable usage is quantified by calculating the total variation (TV) of the input (u), which is the sum of all its moves up and down. If we discretize the input signal as a sequence [u₁, u₂, u₃ . . . , uᵢ . . . ] then

$$T V = {\sum }_{i = 1}^{∞} \vert {u}_{i + 1} - {u}_{i} \vert .$$

Note that TV is the integral of the absolute value of the derivative of the input,

$$T V = {\int }_{0}^{∞} \vert \frac{d u}{d t} \vert d t ,$$

so TV is a good measure of the smoothness (Shamsuzzoha, M.; Skogestad, S. The setpoint overshoot method: A simple and fast closed-loop approach for PID tuning. J. Process Control, 2010, 20, 1220-1234, Skogestad, S. Simple analytic rules for model reduction and PID controller tuning, J. Process Control, 2003, 13, 291-309, Shamsuzzoha, M.; Lee, M. IMC-PID controller design for improved disturbance rejection, Ind. Eng. Chem. Res. 2007, 46, 2077-2091, Shamsuzzoha, M.; Lee, M. Design of advanced PID controller for enhanced disturbance rejection of second order process with time delay. AIChE, 2008, 54, 1526-1536, each incorporated herein by reference).

To evaluate the robustness, compute the maximum closed-loop sensitivity, defined as Mₛ=max_{ω}|1/[1+g c(jω)]|. Since Mₛ is the inverse of the shortest distance from the Nyquist curve of the loop transfer function to the critical point (−1, 0), a small Mₛ-value indicates that the control system has a large stability margin. It is recommended to have IAE, TV and Mₛ all to be small, but for a well tuned controller there is a trade-off, which means that a reduction in IAE implies an increase in TV and Mₛ (and vice versa).

For each process, PI/PID settings were obtained based on step response experiments with three different overshoot (about 0.1, 0.3 and 0.6) and compared with the recently published method “The setpoint overshoot method” (Shamsuzzoha, M.; Skogestad, S. The setpoint overshoot method: A simple and fast closed-loop approach for PID tuning. J. Process Control, 2010, 20, 1220-1234, incorporated herein by reference). The results in Table 1 is only listed for the case of overshoot around 0.3, one can easily obtain the result for other overshoots. The closed-loop performance is evaluated by introducing a unit step change in both the set-point and load disturbance i.e, (yₛ=1 and d=1).

The results for 33 example processes, which were studied by the Shamsuzzoha and Skogestad (Shamsuzzoha, M.; Skogestad, S. The setpoint overshoot method: A simple and fast closed-loop approach for PID tuning. J. Process Control, 2010, 20, 1220-1234, incorporated herein by reference) are listed in Table 1, it is without detuning (F=1). For first-order processes (E14, E15, E16), a small delay must be added (E14a, E15a, E16a) to be able to get the closed-loop overshoot needed to apply the disclosed method.

The comparison of the performance and robustness matrix for overshoot around 30% shows that the disclosed controller setting response gives both smaller overshoot and faster disturbance rejection than the setpoint overshoot method. It also gives significant advantage in overshoot and settling time, particularly in disturbance rejection. The closed-loop response for both the set-point tracking and disturbance rejection confirms the superior response of the disclosed method. It provides the better controller setting for all cases with respect to both the performance and robustness. To show the effectiveness of the disclosed method eight cases of the simulation are shown below, which covers wide range of the processes. The simulations illustrated in figures for two different overshoot (around 0.3 and 0.6) are compared with the setpoint overshoot method (Shamsuzzoha, M.; Skogestad, S. The setpoint overshoot method: A simple and fast closed-loop approach for PID tuning. J. Process Control, 2010, 20, 1220-1234, incorporated herein by reference).

### EXAMPLES

$$\begin{matrix}\frac{1}{( s + 1 ) ( 0.2 s + 1 )} & E1 \\ \frac{1}{( s + 1 ) ( 0.2 s + 1 ) ( 0.04 s + 1 ) ( 0.008 s + 1 )} & E5 \\ \frac{1}{{s ( s + 1 )}^{2}} & E8 \\ \frac{( - s + 1 ) {e}^{- s}}{( 6 s + 1 ) {( 2 s + 1 )}^{2}} & E11 \\ \frac{{e}^{- s}}{( 5 s + 1 )} & E17 \\ {e}^{- s} & E21 \\ \frac{{e}^{- s}}{s} & E24 \\ \frac{{e}^{- s}}{( 5 s - 1 )} & E33\end{matrix}$$

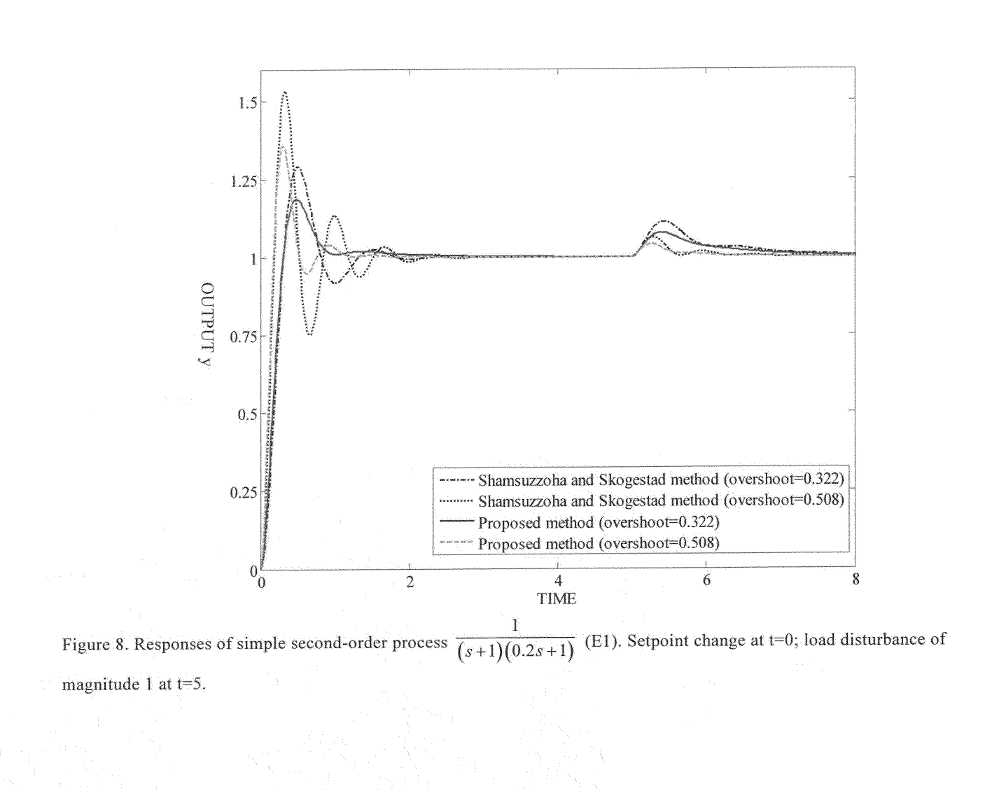

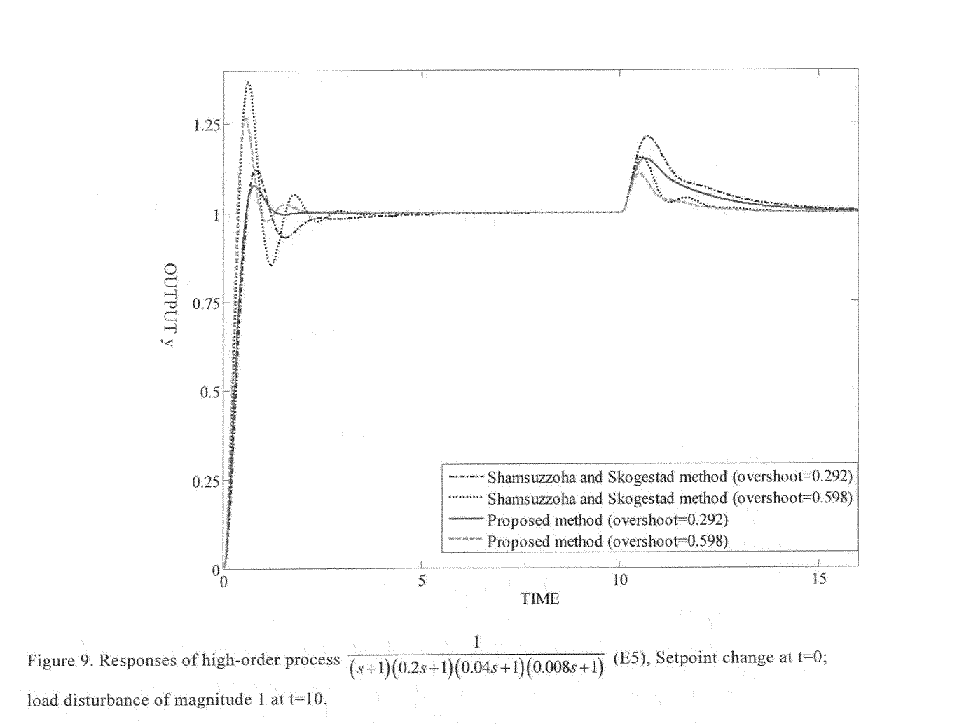

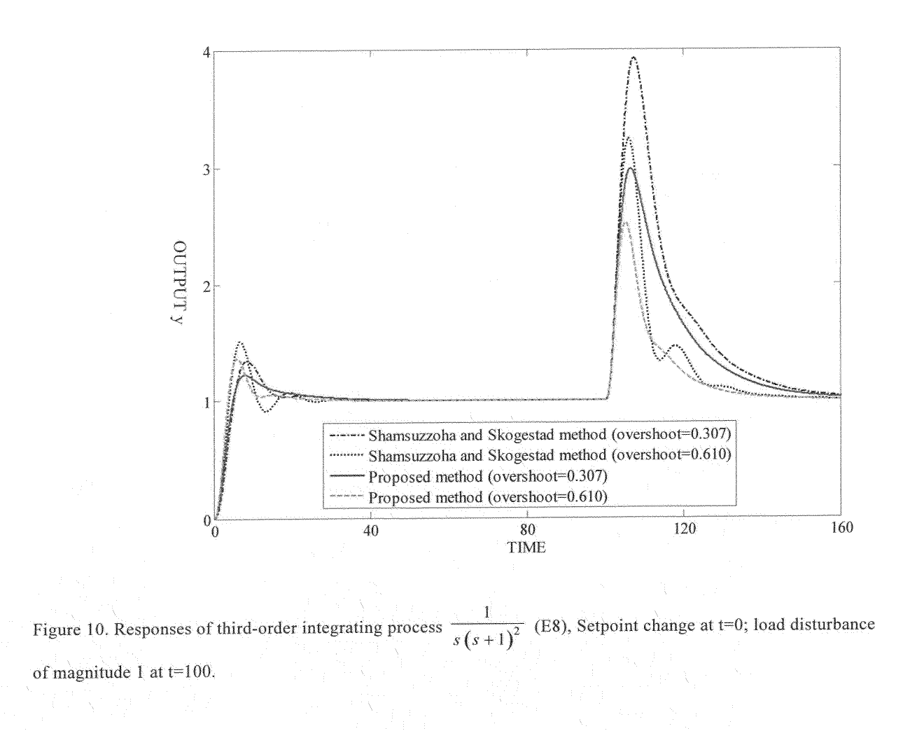

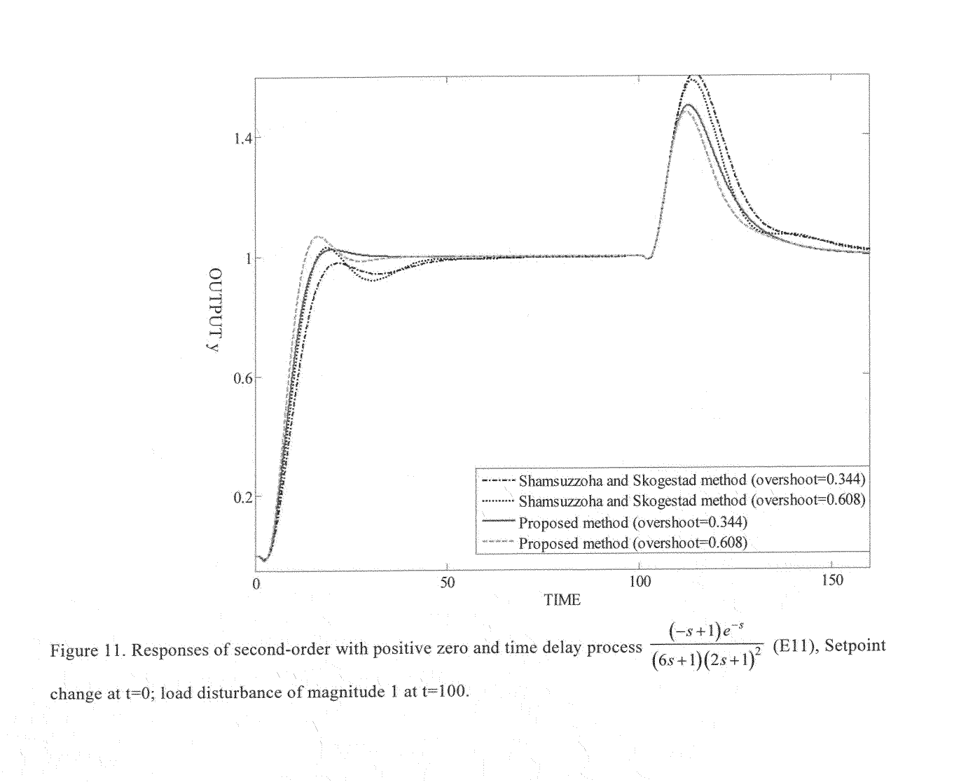

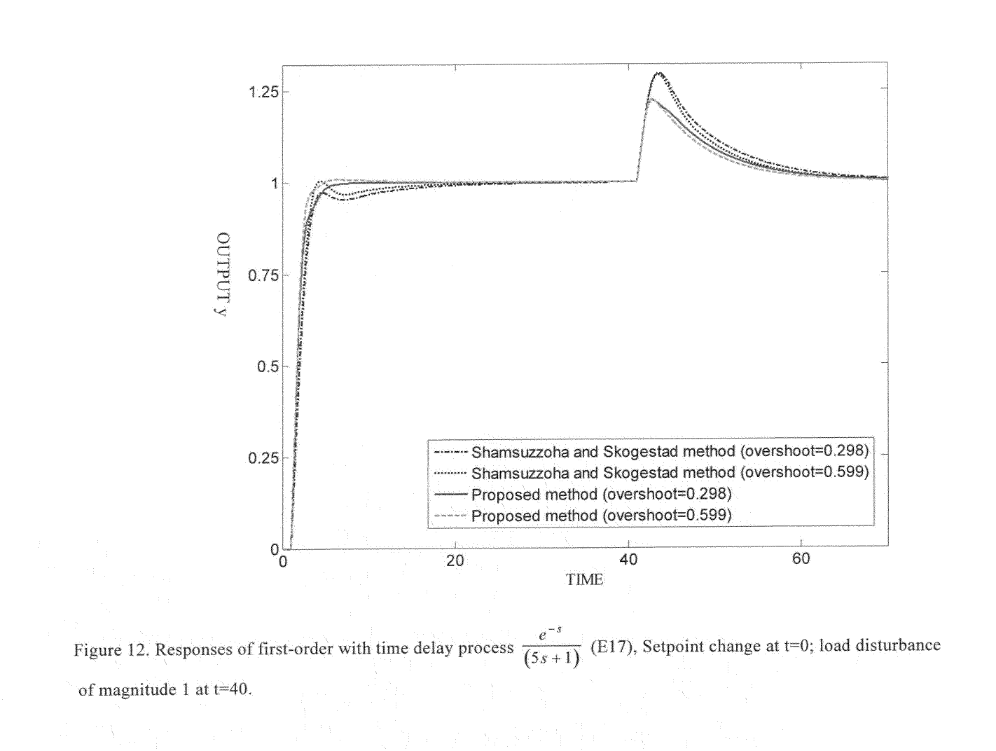

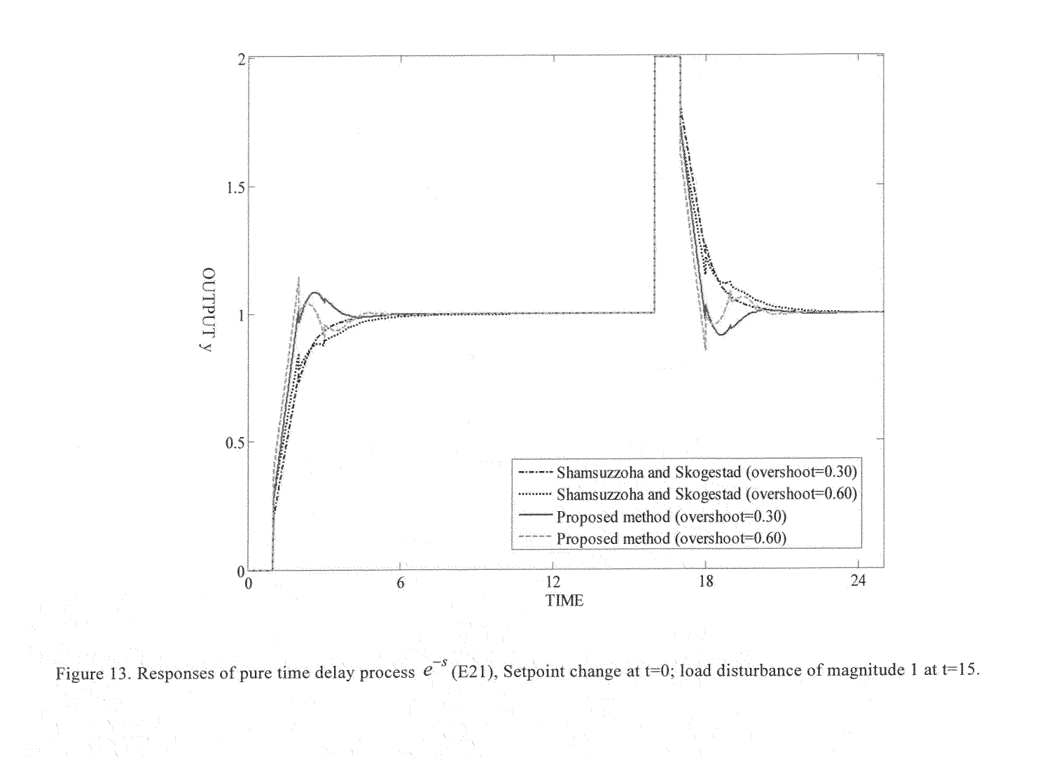

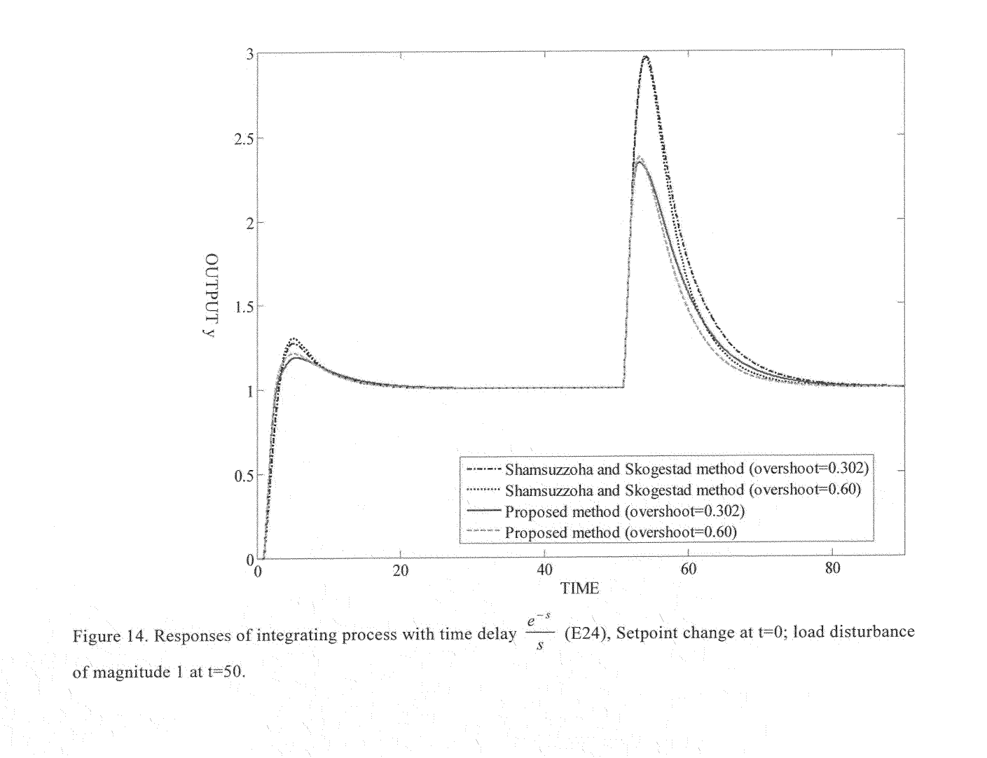

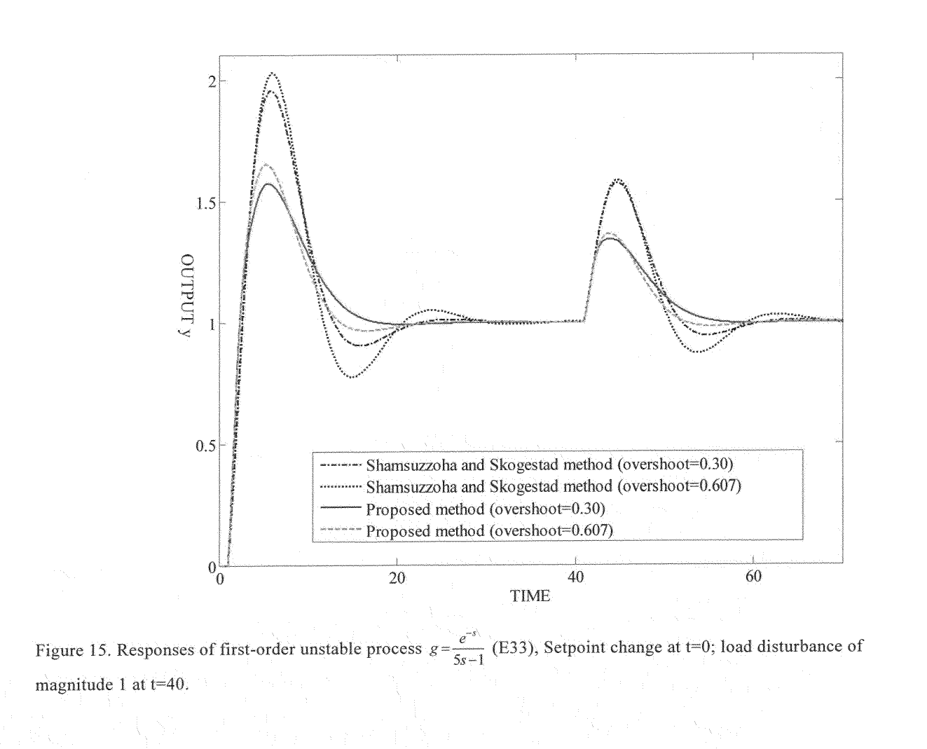

FIGS. 8-15 present a comparison of the disclosed method by introducing a unit step change in the set-point and an unit step change of load disturbance at plant input. It is clear from FIGS. 8-15 that the disclosed method constantly gives better closed-loop response for several type of processes. There are significant performance improvements in all the cases for the disturbance rejection while maintaining setpoint performance.

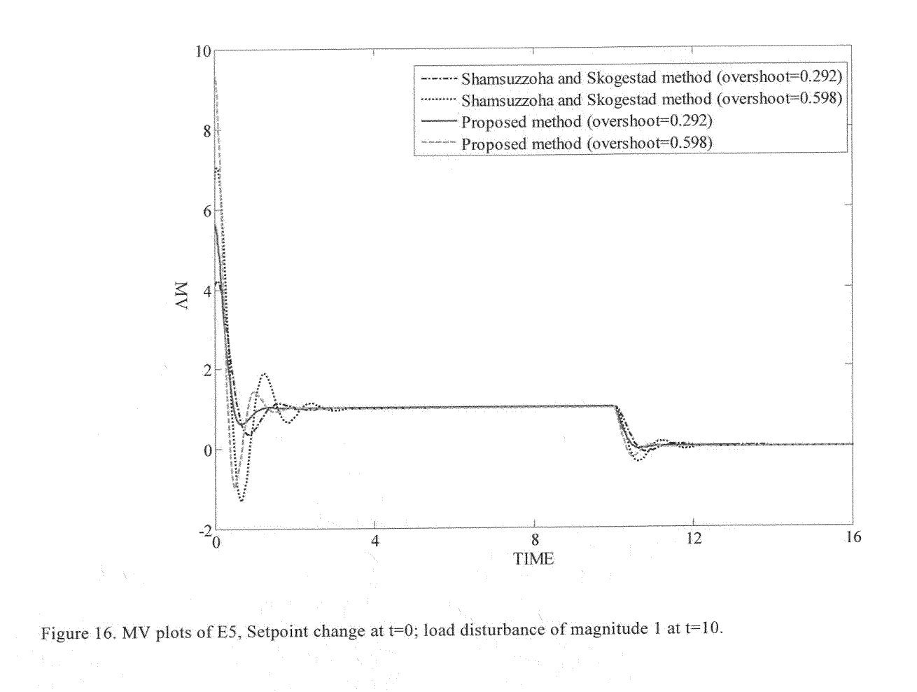

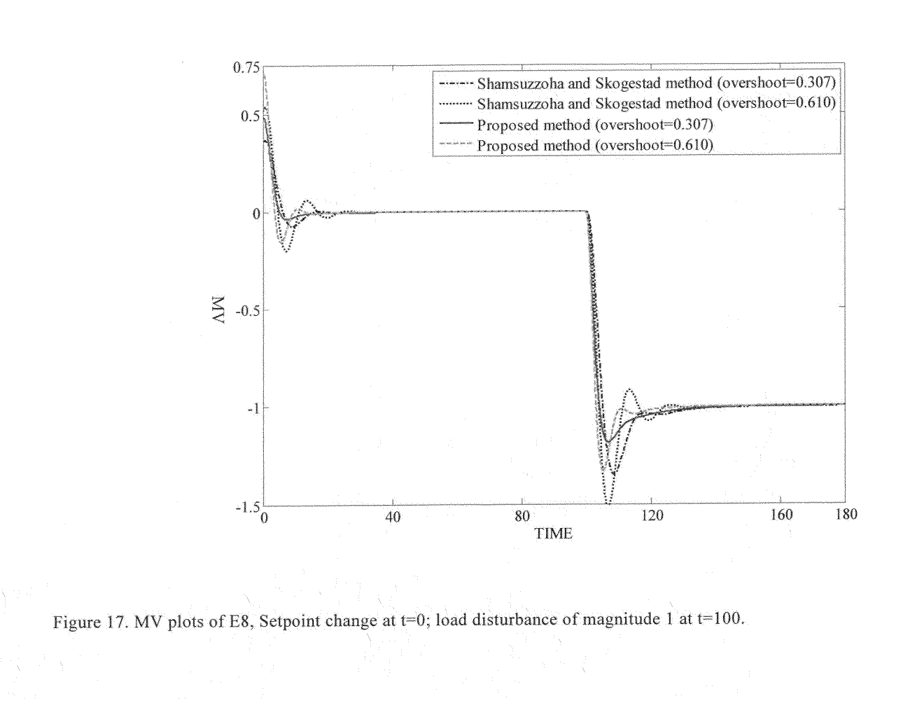

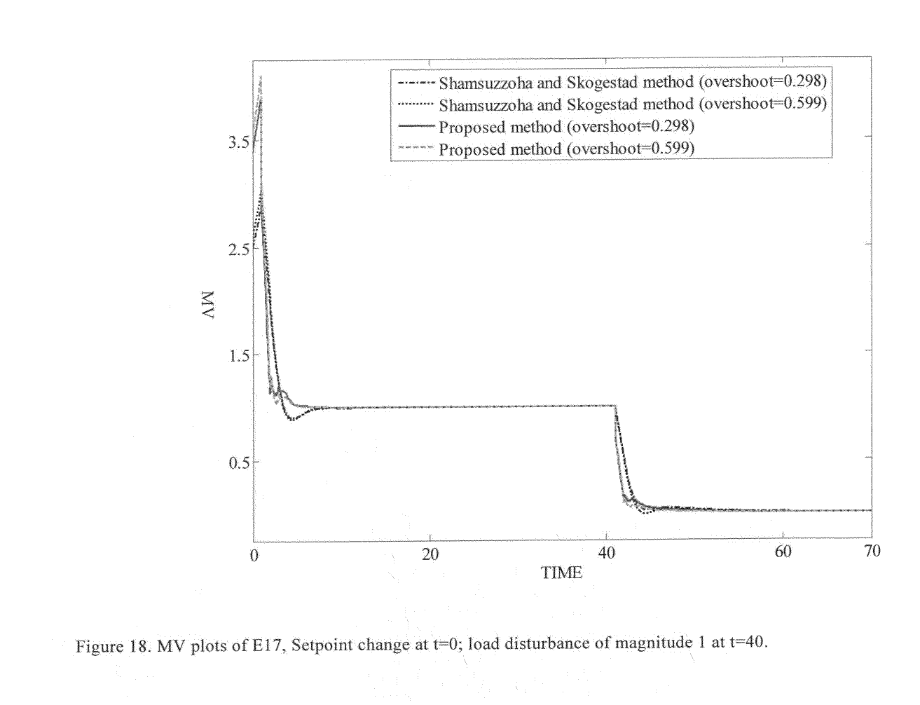

FIGS. 16-18 show the manipulated variable (MV) response of E5, E8 and E17 as the representative cases. In the beginning of FIG. 16, the sharp spikes in the manipulated variable is due to the derivative action. As mentioned earlier TV is a good measure of the smoothness of an output signal. The values of TV are also provided in Table 1 for all 33 processes.

The disclosed method has been also compared to the Lubyen (Luyben, W. L. Getting more information from Relay-Feedback tests, Ind. Eng. Chem. Res. 2001, 40, 4391-4402, incorporated herein by reference). Relay-Feedback test method for a first-order lag process with k=τ=1 and deadtimes of θ=0.1, 1 and 10. The parameters of the PI controller settings for the Ziegler-Nichols (ZN), IMC and Tyreus-Luyben (TL) were taken from Luyben (Luyben, W. L. Getting more information from Relay-Feedback tests, Ind. Eng. Chem. Res. 2001, 40, 4391-4402, incorporated herein by reference).

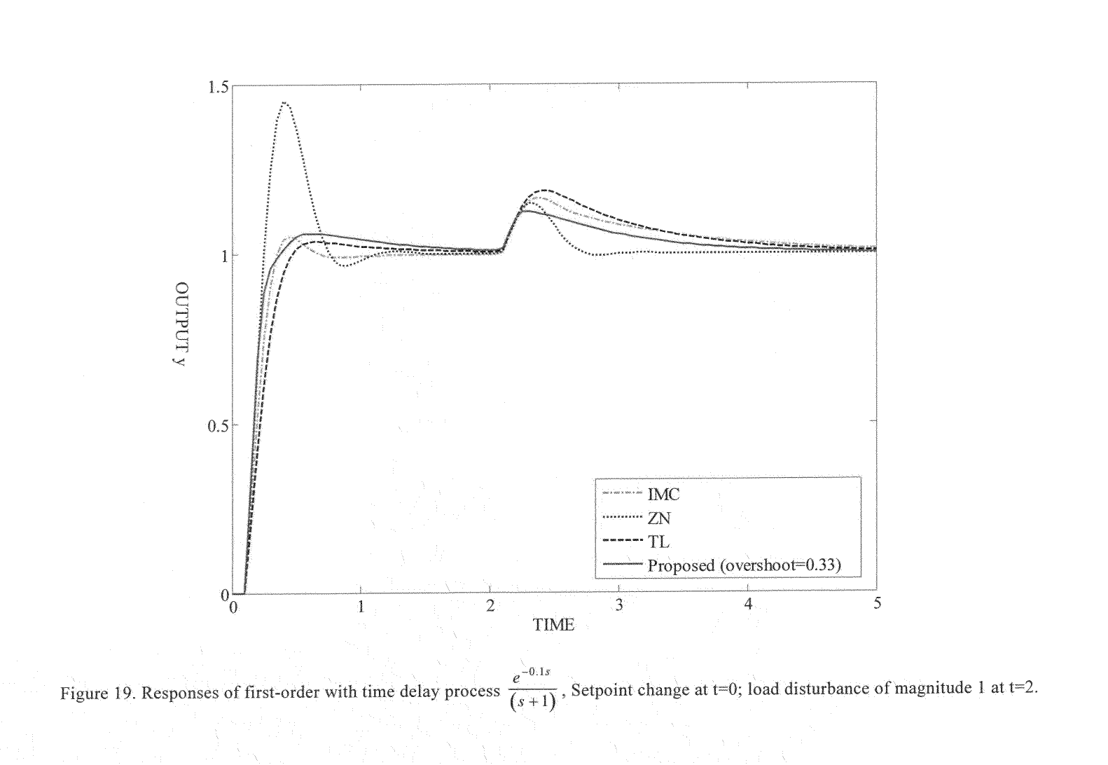

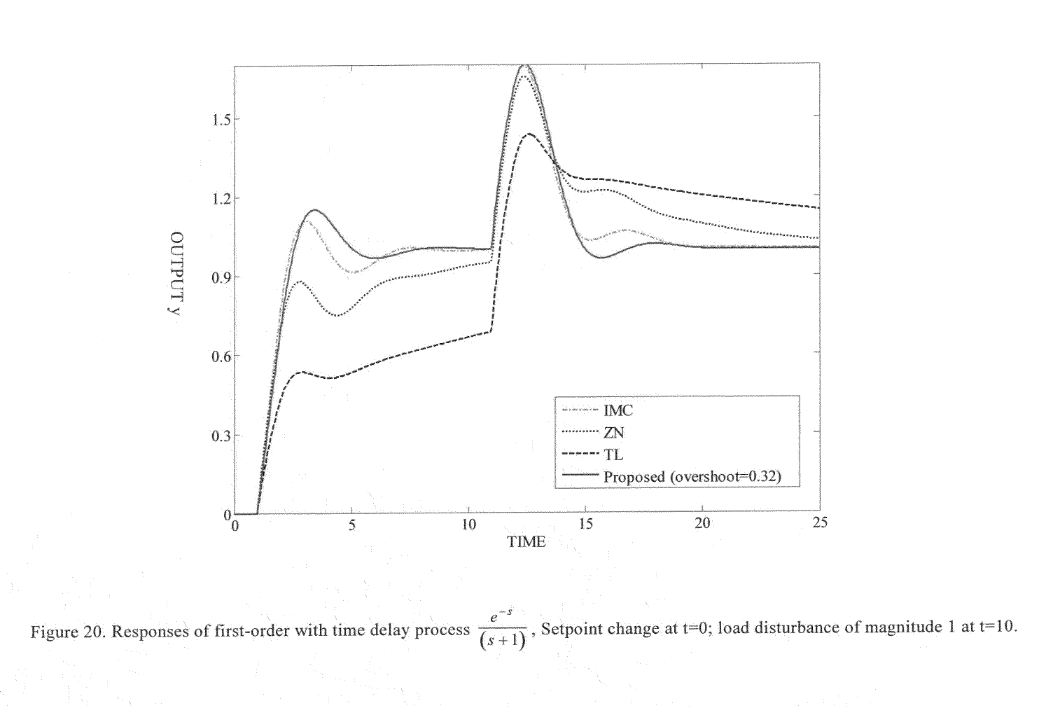

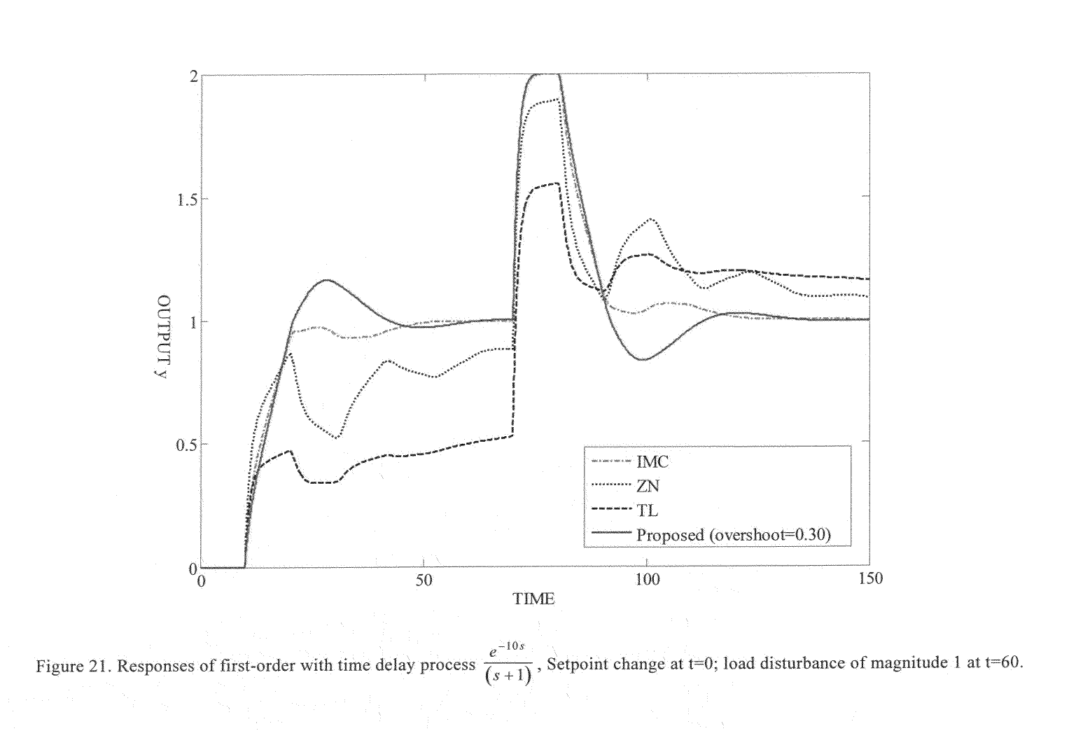

Although the results for the disclosed method have been compared for three different overshoot (around 0.1, 0.3 and 0.6), it is shown only overshoot around 0.3 in FIG. 19-21. The result of lag dominant process, i.e. θ/τ=0.1, the ZN method shows aggressive response while IMC and TL exhibit similar response. For the large θ/τ ratio, the closed-loop response of the ZN and TL methods are very sluggish as shown in FIG. 21. From FIGS. 19-21, it is clear that the disclosed method consistently gives better performance for wide range of θ/τ ratio.

Even though the response is not shown, simulation has been conducted for the process g(s)=(⅛)e^{-θs}/(s+1)³ for deadtime θ=0.1, 1 and 10. It clearly shows that the disclosed method has significant advantage over Lubyen¹⁴ method for the high order process as well.

It is important to mention that the overshoot around 0.1 typically gives slower and more robust PI/PID-settings, whereas a large overshoot around 0.6 gives more aggressive settings. It is good because a more careful step response results in more careful tunings settings.

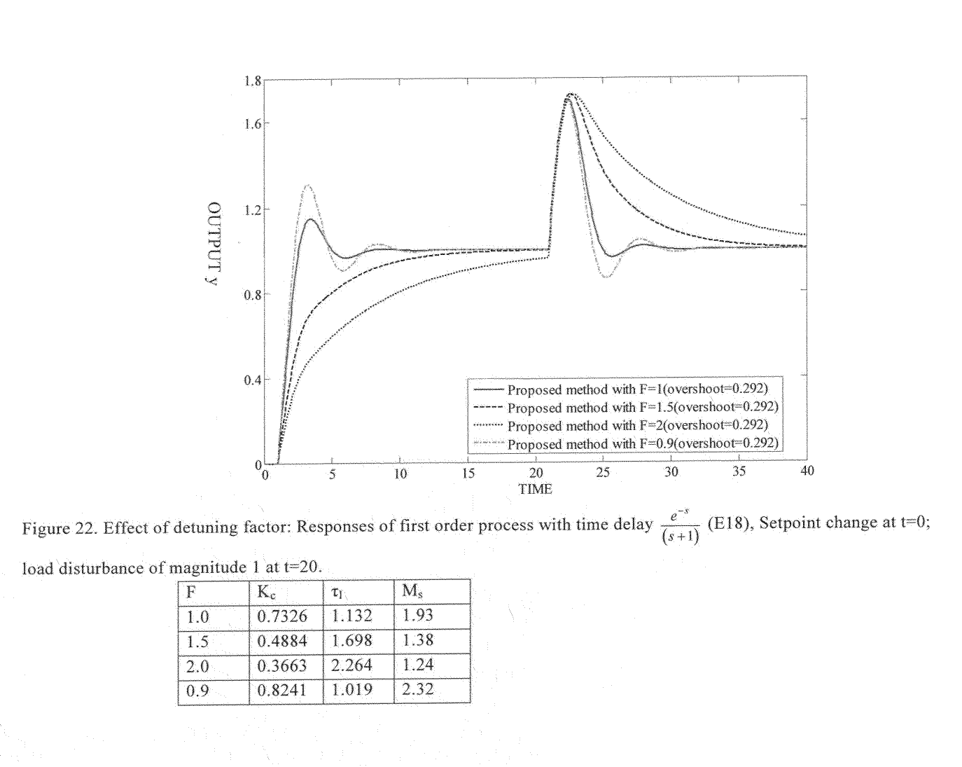

The effect of using the detuning factor F is illustrated in FIG. 22 using a first order process with time delay (E18). As expected, using F>1 results in more robust controller settings.

A standard of using lead-lag set-point filter may be used to remove the excessive overshoot from the sepoint response in the disclosed method if it is required in practice (Shamsuzzoha, M.; Lee, M. IMC-PID controller design for improved disturbance rejection, Ind. Eng. Chem. Res. 2007, 46, 2077-2091, Shamsuzzoha, M.; Lee, M. Design of advanced PID controller for enhanced disturbance rejection of second order process with time delay. AIChE, 2008, 54, 1526-1536, Chen, D.; Seborg, D. E. PI/PID controller design based on direct synthesis and disturbance rejection. Ind. Eng. Chem. Res. 2002, 41, 4807-4822, each incorporated herein by reference).

The disclosed closed-loop method is based on the IMC-PID tuning rule given in Eq. (11). Therefore, it is interesting to compare the results of both the methods and ensure the effectiveness of the disclosed closed-loop method.

To compare the results of the both the method three typical process model has been considered and those are given below

$$\begin{matrix}\frac{( - s + 1 ) {e}^{- s}}{( 6 s + 1 ) {( 2 s + 1 )}^{2}} & E11 \\ \frac{{e}^{- s}}{5 s + 1} & E17 \\ \frac{100 {e}^{- s}}{100 s + 1} & E22\end{matrix}$$

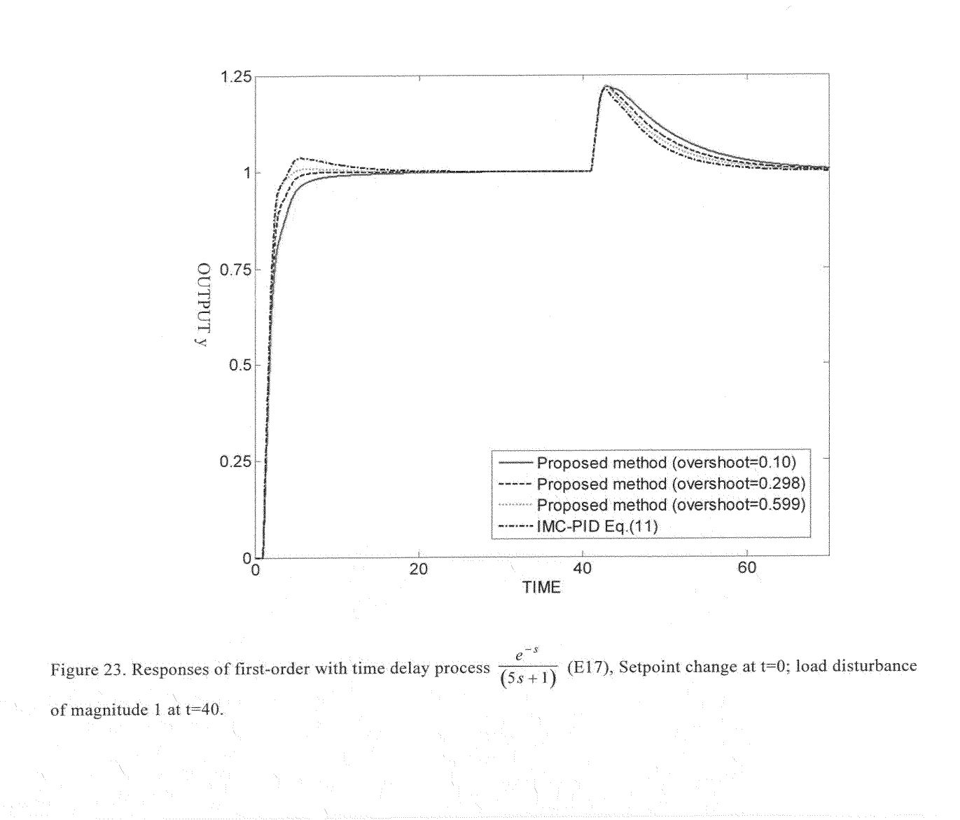

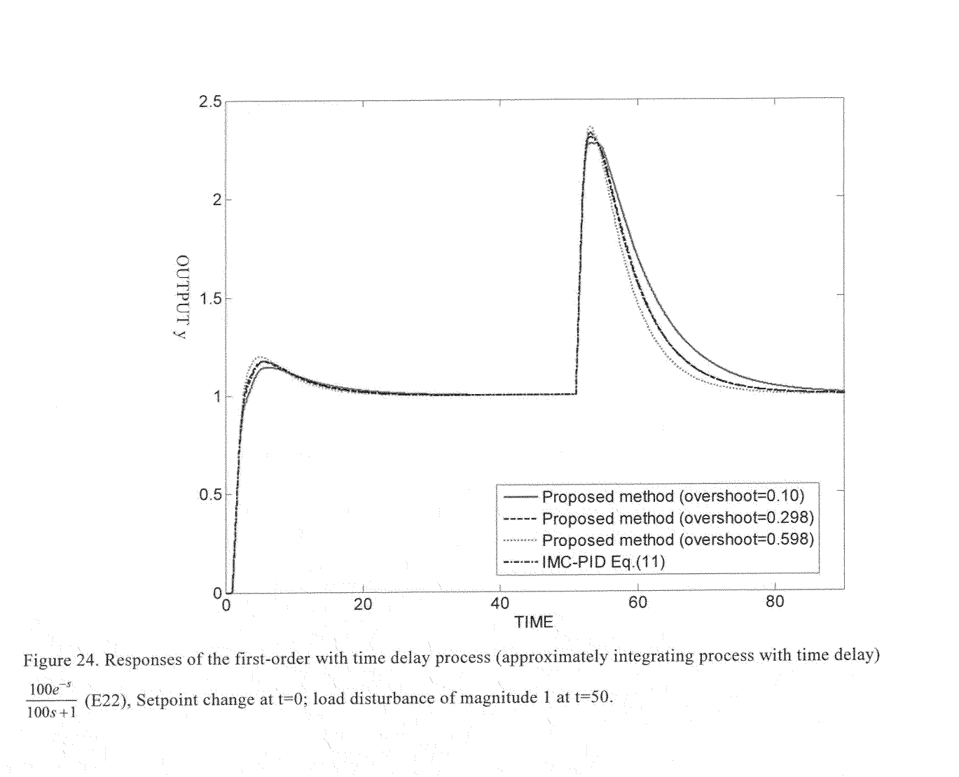

E17 and E22 are first-order plus delay processes, similar to those used to develop the method. E22 is almost a integrating with delay process. The output responses of the disclosed method are similar to the IMC-PID responses which is shown in FIGS. 23 and 24. It seems that the response is almost independent of the value of the overshoot in all three cases.

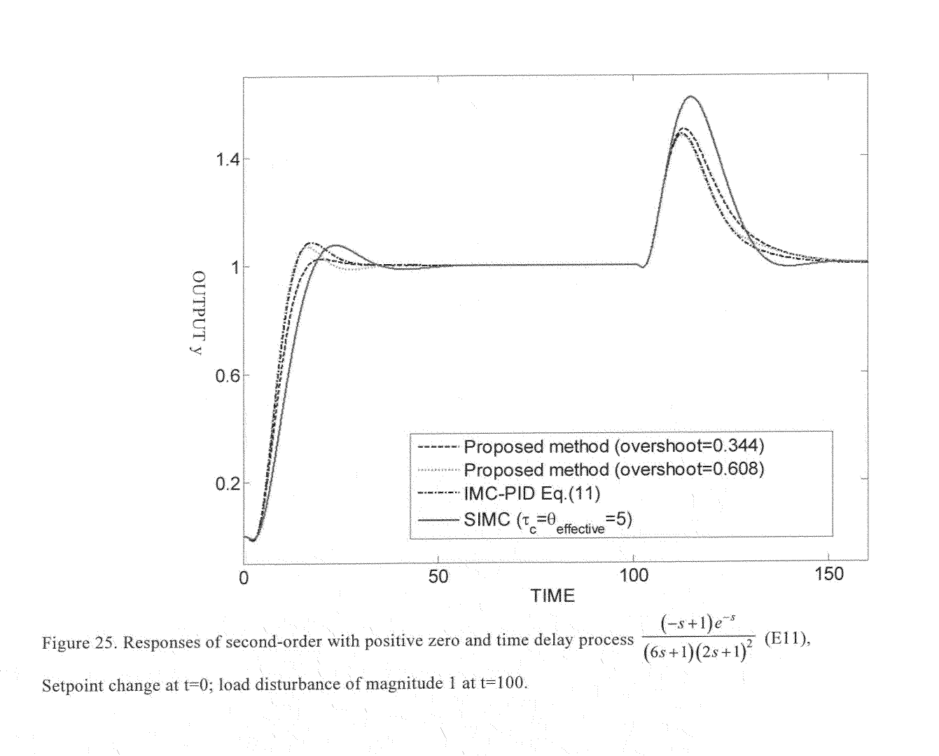

The comparison of the disclosed and IMC-PID method has been conducted for the high order process (E11), and result is shown in FIG. 25. The model reduction technique (Half rule, Skogestad, S. Simple analytic rules for model reduction and PID controller tuning, J. Process Control, 2003, 13, 291-309, incorporated herein by reference) has been utilized to obtain the first order plus delay process and resulting process parameters are obtained as k=1, τ=7 and θ=5. As expected, the output result of the disclosed method and approximated IMC-PID is close enough, its agreement with the IMC-PID method is best for the intermediate overshoot (around 0.3).

The disclosed tuning method is based on the IMC-PID tuning rule given in Eq. (11) whereas the setpoint overshoot method (Shamsuzzoha, M.; Skogestad, S. The setpoint overshoot method: A simple and fast closed-loop approach for PID tuning. J. Process Control, 2010, 20, 1220-1234, incorporated herein by reference) is based on the SIMC rule (Skogestad, S. Simple analytic rules for model reduction and PID controller tuning, J. Process Control, 2003, 13, 291-309, incorporated herein by reference). It is important to note that the performance of both the disclosed and the setpoint overshoot method mainly depends upon their original tuning rule.

The performance of the SIMC and IMC-PID has been compared and also shown in FIG. 25 for the high order process plus time delay (E11). The figure clearly shows that the IMC-PID tuning rule gives better performance than SIMC rule. The same observations have been found for the several other processes, though it is not shown. It is assumed that the best controller tuning method results in the best closed-loop output response. However, since both the methods utilize some kind of model reduction techniques to convert the PI/PID controller to the closed-loop method, an approximation error necessarily occurs. On the basis of above observation, it is clear that the disclosed method has better performance because of superior performance in its original IMC-PID tuning rule.

The disclosed method has advantage over other PI/PID tuning method because of its simplicity and consistently better performance and robustness for broad class of the processes. It also has limitation because of step test experiment in setpoint change, which might perturb the process even for a short period of time.

Sometimes in the chemical process industries, setpoint step test experiment is not desirable due to several reasons. For example, changing the setpoint of a column temperature loop is not recommended because of off-specification of the products. Due to these reason, occasionally there may be limitation in setpoint step test in chemical process industries. The disclosed method is based on the step test in closed-loop with proportional controller (K_{c0}). Suitable selection of initial controller gain (K_{c0}) and subsequently number of trials can significantly reduce the time of step test experiment and eventually off-specification in the product. One can stop the closed-loop experiment just after obtaining the information of first peak and valley. The required information (overshoot, tₚ) can be obtained after first peak and valley and then Eq. (12) can be utilized to obtain parameter b. Along with these lines one can reduce the off-specification of the product during controller tuning. It is not recommended to use large test signal amplitudes because that will cause off-specification of product and/or will excite nonlinearity.

Conclusions:

A simple approach has been developed for PI/PID controller tuning by the closed-loop setpoint step experiment using a P-controller with gain K_{c0}. The PI/PID-controller settings are obtained directly from following three data from the setpoint experiment:
Overshoot, (Δyₚ−Δy_{∞})/Δy_{∞}
Time to reach overshoot (first peak), tₚ
Relative steady state output change, b=Δy_{∞}/Δyₛ.

If one does not want to wait for the system to reach steady state and speedup the closed-loop experiment, it is recommended to use the estimate Δy_{∞}=0.45(Δyₚ+Δyᵤ). In conclusion, the final tuning formula for the disclosed “Shams' closed-loop tuning method” is summarized as:

$$\begin{matrix}{K}_{c} = {K}_{c 0} A \text{/} F & \\ {τ}_{I} = min ( 0.645 A \vert \frac{b}{( 1 - b )} \vert {t}_{p} F , 2.44 {t}_{p} F ) & \\ {τ}_{D} = 0.14 {t}_{p} if A \vert \frac{b}{( 1 - b )} \vert \geq 1 & \end{matrix}$$

where, A=[1.55 (overshoot)²−2.159 (overshoot)+1.35]

F is a detuning parameter. F=1 gives the “fast and robust” PI/PID settings corresponding to τ_{c}=θ. To detune the response and get more robustness one can selects F>1, but in special cases one may select F<1 to speed up the closed-loop response.

An overshoot of around 0.3 is recommended for the better response in the disclosed method. The initial controller gain (K_{c01}) which gives overshoot around 0.3 in the closed-loop test can be obtained from equation below:

K_{c0}=1.19(1.55(OS₁)²−2.159(OS₁)+1.35)K_{c01}

The disclosed method works well for a wide variety of the processes typical for process control applications, including the standard first-order plus delay processes as well as integrating, high-order, inverse response, unstable and oscillating process.

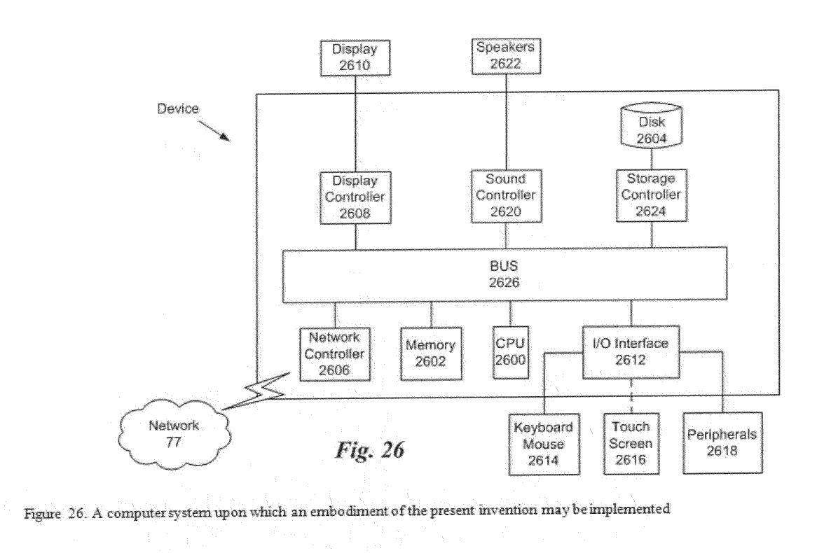

Next, a hardware description of a device according to exemplary embodiments is described with reference to FIG. 26. In FIG. 26, the device includes a CPU 2600 which performs the processes described above. The process data and instructions may be stored in memory 2602. These processes and instructions may also be stored on a storage medium disk 2604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 2600 and an operating system such as Microsoft Windows 7, UNIX, Solaris, LINUX, Apple MAC-OS and other systems known to those skilled in the art.

CPU 2600 may be a Xenon or Core processor from Intel of America or an Opteron processor from AMD of America, or may be other processor types that would be recognized by one of ordinary skill in the art. Alternatively, the CPU 2600 may be implemented on an FPGA, ASIC, PLD or using discrete logic circuits, as one of ordinary skill in the art would recognize. Further, CPU 2600 may be implemented as multiple processors cooperatively working in parallel to perform the instructions of the inventive processes described above.

The device in FIG. 26 also includes a network controller 2606, such as an Intel Ethernet PRO network interface card from Intel Corporation of America, for interfacing with network 77. As can be appreciated, the network 77 can be a public network, such as the Internet, or a private network such as an LAN or WAN network, or any combination thereof and can also include PSTN or ISDN sub-networks. The network 77 can also be wired, such as an Ethernet network, or can be wireless such as a cellular network including EDGE, 3G and 4G wireless cellular systems. The wireless network can also be WiFi, Bluetooth, or any other wireless form of communication that is known.

The device further includes a display controller 2608, such as a NVIDIA GeForce GTX or Quadro graphics adaptor from NVIDIA Corporation of America for interfacing with display 2610, such as a Hewlett Packard HPL2445w LCD monitor. A general purpose I/O interface 2612 interfaces with a keyboard and/or mouse 2614 as well as a touch screen panel 2616 on or separate from display 2610. General purpose I/O interface also connects to a variety of peripherals 2618 including printers and scanners, such as an OfficeJet or DeskJet from Hewlett Packard.

A sound controller 2620 is also provided in the device, such as Sound Blaster X-Fi Titanium from Creative, to interface with speakers/microphone 2622 thereby providing sounds and/or music.

The general purpose storage controller 2624 connects the storage medium disk 2604 with communication bus 2626, which may be an ISA, EISA, VESA, PCI, or similar, for interconnecting all of the components of the device. A description of the general features and functionality of the display 2610, keyboard and/or mouse 2614, as well as the display controller 2608, storage controller 2624, network controller 2606, sound controller 2620, and general purpose I/O interface 2612 is omitted herein for brevity as these features are known.

In one embodiment the present disclosure has the advantage of being a reduced complexity method in closed-loop mode.

In another embodiment the present disclosure is a one step method where one may directly get controller tuning setting parameters for the broad class of the processes. No detail prior information of the plant (process parameters k, θ and τ) is required to obtain the robust controller setting from the closed-loop setpoint experiment.

In another embodiment the present disclosure is analytically derived and applicable to different types of processes with a wide range of process parameters in a unified framework.

In another embodiment the present disclosure is applicable to a wide range of overshoot (approximately 10-60%) with the initial controller gain K_{c0}.

In another embodiment the present disclosure removes all the shortcomings of the famous Ziegler-Nichols continuous cycling method.

In another embodiment of the present disclosure PID controller is widely used in the process industries, oil and gas, pharmaceutical and food industries. It is because of its simplicity, robustness and wide ranges of applicability in the regulatory control layer. Companies such as process industries like SABIC, SIPCHEM, oil and gas like Aramco, engineering providers like Honeywell and Yokagawa, and other chemical and pharmaceutical companies, and food industries may be interested in the present disclosure.

In one embodiment of the present disclosure the controller integral and derivative time (τ_{I} and τ_{D}) is mainly a function of the time to reach the first peak (tₚ). The method of the present disclosure works for the wide range of overshoot of approximately 10-60%.

In another embodiment the method of the present disclosure is a general method, which may be applicable to different types of systems without any prior information of the process model. The method of the present disclosure works for stable, integrating and even unstable processes with time delay. There is no limitation on the type and order of the process model in the method of the present disclosure. The method of the present disclosure is applicable to both linear and nonlinear processes.

In another embodiment the method of the present disclosure may find the controller tuning setting in one step. It is not required to first obtain the process parameters, i.e., process gain, time constant and time delay. The method of the present disclosure may start with the original process gain in auto mode. The method requires closed-loop step setpoint experiments using a proportional only controller with gain K_{c0}. The method obtains several parameters in the closed loop test e.g., initial gain, overshoot, time to reach the first peak (tₚ) and steady state offset. Based on this information the method of the present disclosure may directly obtain the controller settings. The disclosed closed-loop tuning method overcomes the shortcoming of the well-known Ziegler-Nichols continuous cycling method and may be an alternative for the same in the efficient way. The method of the present disclosure is a simple method to obtain the PI/PID setting which gives the acceptable performance and robustness for a broad range of the processes.

The method of the present disclosure is practical to implement by not needing initial guess of the parameters.

The method of the present disclosure provides a response for an overshoot, preferably the overshoot is between 10-60% for a broad class of processes. Improved response is obtained with an overshoot around 30%.

The method of the present disclosure saves run times by providing analytical tuning based on the initial controller gain, overshoot, time to reach first peak and relatively steady state output change.

The thesis of “Closed-loop PI/PID Controller Tuning Method for stable and Integrating Process with time Delay” by Mohammad Shamsuzzoha, at the Department of Chemical Engineering, King Fand University of Petroleum and Minerals, Dhahran, 31261, Kingdom of Saudi Arabia, August 2013 is incorporated herein by reference in its entirety.

TABLE 1
PI/PID controller setting for disclosed method (F = 1) and comparison with “The setpoint overshoot method” (hereafter, SOM
method¹).

| | | | | | | | Resulting PI/PID-controller with performance and robustness index | | | | | | | |
|---|---|---|---|---|---|---|---|---|---|---|---|---|---|---|
| | | | | | | | | | | | | | Load | |
| | | | P-control setpoint experiment | | | | | | | | Setpoint | | disturbance | |
| | | Meth- | | over- | | | | | | | IAE | | IAE | |
| Case | Process model | ods | K_{c0} | shoot | tₚ | b | K_{c} | τ_{I} | τ_{D} | Mₛ | (y) | TV(u) | (y) | TV(u) |
| E1 | $\frac{1}{( s + 1 ) ( 0.2 s + 1 )}$ | SOM dis- closed | 15.0 15.0 | 0.322 0.322 | 0.393 0.393 | 0.937 0.937 | 9.03 12.29 | 0.958 0.958 | — 0.055 | 1.74 1.20 | 0.30 0.26 | 23.72 27.19 | 0.11 0.78 | 1.81 1.35 |
| E2 | $\frac{( - 0.3 s + 1 ) ( 0.08 s + 1 )}{\begin{matrix}( 2 s + 1 ) ( s + 1 ) ( 0.4 s + 1 ) \\ ( 0.2 s + 1 ) ( 0.05 s + 1\end{matrix}}$ | SOM dis- closed | 0.85 0.85 | 0.131 0.131 | 5.31 5.31 | 0.46 0.46 | 0.688 1.263 | 3.14 3.62 | — 0.623 | 1.41 1.87 | 4.56 2.89 | 1.20 2.13 | 4.57 2.87 | 1.01 1.043 |
| E3 | $\frac{2 ( 15 s + 1 )}{\begin{matrix}( 20 s + 1 ) ( s + 1 ) \\ {( 0.1 s + 1 )}^{2}\end{matrix}}$ | SOM dis- closed | 5.0 5.0 | 0.314 0.314 | 0.527 0.527 | 0.909 0.909 | 3.043 4.14 | 1.287 1.29 | — 0.074 | 1.70 1.36 | 0.43 0.37 | 7.16 8.64 | 0.43 0.312 | 1.48 1.21 |
| E4 | $\frac{1}{{( s + 1 )}^{4}}$ | SOM dis- closed | 1.25 1.25 | 0.304 0.304 | 5.25 5.250 | 0.556 0.556 | 0.77 1.05 | 3.49 3.55 | — 0.735 | 1.56 1.37 | 4.50 3.43 | 1.49 1.69 | 4.50 3.38 | 1.09 1.0 |
| E5 | $\frac{1}{\begin{matrix}( s + 1 ) ( 0.2 s + 1 ) \\ ( 0.04 s + 1 ) ( 0.008 s + 1 )\end{matrix}}$ | SOM dis- closed | 6.50 6.50 | 0.292 0.292 | 0.615 0.615 | 0.867 0.867 | 4.093 5.57 | 1.50 1.50 | — 0.086 | 1.59 1.26 | 0.46 0.347 | 9.13 11.11 | 0.37 0.27 | 1.42 1.15 |
| E6 | $\frac{{( 0.17 s + 1 )}^{2}}{{s ( s + 1 )}^{2} ( 0.028 s + 1 )}$ | SOM dis- closed | 0.80 0.80 | 0.301 0.301 | 4.987 4.987 | 1.0 1.0 | 0.496 0.675 | 12.17 12.17 | — 12.17 | 1.77 1.28 | 4.74 4.39 | 1.29 1.47 | 24.51 18.03 | 1.81 1.41 |
| E7 | $\frac{- 2 s + 1}{{( s + 1 )}^{3}}$ | SOM dis- closed | 0.40 0.40 | 0.309 0.309 | 5.98 5.98 | 0.286 0.286 | 0.245 0.334 | 1.263 1.286 | — — | 2.13 3.15 | 7.04 8.80 | 1.57 2.77 | 8.62 10.56 | 1.83 3.10 |
| E8 | $\frac{1}{{s ( s + 1 )}^{2}}$ | SOM dis- closed | 0.58 0.58 | 0.307 0.307 | 6.19 6.19 | 1.0 1.0 | 0.357 0.485 | 15.10 15.10 | — 0.87 | 1.75 1.34 | 6.21 5.73 | 0.90 1.05 | 42.33 31.13 | 1.72 1.38 |
| E9 | $\frac{{e}^{- s}}{{( s + 1 )}^{2}}$ | SOM dis- closed | 1.0 1.0 | 0.321 0.321 | 3.85 3.85 | 0.50 0.50 | 0.603 0.82 | 1.995 2.033 | — — | 1.58 1.92 | 3.31 3.04 | 1.27 2.09 | 3.31 2.53 | 1.04 1.43 |
| E10 | $\frac{{e}^{- s}}{( 20 s + 1 ) ( 2 s + 1 )}$ | SOM dis- closed | 8.0 8.0 | 0.301 0.301 | 8.425 8.425 | 0.889 0.889 | 4.966 6.754 | 20.56 20.56 | — 1.18 | 1.62 1.35 | 5.92 5.69 | 10.99 13.74 | 4.14 3.042 | 1.34 1.11 |
| E11 | $\frac{( - s + 1 ) {e}^{- s}}{( 6 s + 1 ) {( 2 s + 1 )}^{2}}$ | SOM dis- closed | 1.40 1.40 | 0.344 0.344 | 13.67 13.67 | 0.583 0.583 | 0.817 1.112 | 9.602 9.786 | — 1.91 | 1.59 1.44 | 11.72 9.27 | 1.60 1.91 | 11.78 8.831 | 1.09 1.06 |
| E12 | $\frac{( 6 s + 1 ) ( 3 s + 1 ) {e}^{- 0.3 s}}{( 10 s + 1 ) ( 8 s + 1 ) ( s + 1 )}$ | SOM dis- closed | 15.0 15.0 | 0.308 0.308 | 0.836 0.836 | 0.938 0.938 | 9.22 12.54 | 2.04 2.04 | — 0.12 | 1.75 1.92 | 0.92 0.82 | 21.54 33.60 | 0.23 0.167 | 1.26 1.53 |
| E13 | $\frac{( 2 s + 1 ) {e}^{- s}}{( 10 s + 1 ) ( 0.5 s + 1 )}$ | SOM dis- closed | 4.75 4.75 | 0.302 0.302 | 2.20 2.20 | 0.826 0.826 | 2.9 4.0 | 5.367 5.367 | — 0.308 | 1.76 2.56 | 2.88 2.51 | 6.60 14.98 | 1.85 1.35 | 1.20 2.58 |
| E14 | $\frac{- s + 1}{s}$ | SOM dis- closed | No oscillation with P-controller, method does not apply No oscillation with P-controller, method does not apply | | | | | | | | | | | |
| E14 (a) | $\frac{( - s + 1 ) {e}^{- 0.1 s}}{s}$ | SOM dis- closed | 0.70 — | 0.285 — | 1.655 — | 1.0 — | 0.445 — | 4.04 — | — — | 2.01 — | 3.58 — | 1.74 — | 11.63 — | 3.40 — |
| E15 | $\frac{- s + 1}{( s + 1 )}$ | SOM dis- closed | No oscillation with P-controller, method does not apply No oscillation with P-controller, method does not apply | | | | | | | | | | | |
| E15 (a) | $\frac{( - s + 1 ) {e}^{- 0.2 s}}{( s + 1 )}$ | SOM dis- closed | 0.51 0.51 | 0.31 0.31 | 1.55 1.55 | 0.338 0.338 | 0.314 0.433 | 0.418 0.432 | — — | 3.90 12.29 | 4.12 11.78 | 3.88 14.52 | 5.26 13.2 | 4.41 15.22 |
| E16 | $\frac{1}{( s + 1 )}$ | SOM dis- closed | No oscillation with P-controller, method does not apply No oscillation with P-controller, method does not apply | | | | | | | | | | | |
| E16 (a) | $\frac{{e}^{- 0.05 s}}{( s + 1 )}$ | SOM dis- closed | 16.0 16.0 | 0.309 0.309 | 0.174 0.174 | 0.941 0.941 | 9.819 13.36 | 0.425 0.425 | — 0.0244 | 1.63 1.73 | 0.16 0.15 | 22.08 30.64 | 0.043 0.032 | 1.32 1.26 |
| E17 | $\frac{{e}^{- s}}{( 5 s + 1 )}$ | SOM dis- closed | 4.0 4.0 | 0.298 0.298 | 3.05 3.05 | 0.80 0.80 | 2.494 3.391 | 6.538 6.658 | — 0.427 | 1.56 1.66 | 2.62 1.97 | 4.96 7.60 | 2.62 1.96 | 1.04 1.22 |
| E18 | $\frac{{e}^{- s}}{( s + 1 )}$ | SOM dis- closed | 0.90 0.90 | 0.326 0.326 | 2.40 2.40 | 0.474 0.474 | 0.538 0.733 | 1.111 1.132 | — — | 1.58 1.93 | 2.09 2.02 | 1.23 1.98 | 2.06 1.64 | 1.03 1.38 |
| E19 | $\frac{{e}^{- s}}{( 0.2 s + 1 )}$ | SOM dis- closed | 0.30 0.30 | 0.292 0.292 | 2.0 2.0 | 0.231 0.231 | 0.189 0.257 | 0.325 0.331 | — — | 1.67 2.08 | 1.88 1.93 | 1.12 1.58 | 1.87 1.90 | 1.10 1.55 |
| E20 | $\frac{{e}^{- s}}{{( 0.05 s + 1 )}^{2}}$ | SOM dis- closed | 0.30 0.30 | 0.30 0.30 | 2.0 2.0 | 0.231 0.231 | 0.187 0.254 | 0.321 0.327 | — — | 1.61 1.98 | 1.74 1.69 | 1.02 1.39 | 1.74 1.69 | 1.01 1.39 |
| E21 | e^{-s} | SOM | 0.30 | 0.30 | 2.0* | 0.231 | 0.187 | 0.321 | — | 1.53 | 1.72 | 1.07 | 1.72 | 1.02 |
| | | dis- | 0.30 | 0.30 | 2.0* | 0.231 | 0.254 | 0.327 | — | 1.84 | 1.46 | 1.35 | 1.46 | 1.35 |
| | | closed | | | | | | | | | | | | |
| E22 | $\frac{100 {e}^{- s}}{100 s + 1}$ | SOM dis- closed | 0.80 0.80 | 0.301 0.301 | 3.293 3.293 | 0.99 0.99 | 0.496 0.675 | 8.034 8.034 | — 0.461 | 1.68 1.72 | 3.79 3.36 | 1.18 1.70 | 16.19 11.9 | 1.50 1.51 |
| E23 | $\frac{( 10 s + 1 ) {e}^{- s}}{s ( 2 s + 1 )}$ | SOM dis- closed | 0.26 0.26 | 0.303 0.303 | 2.563 2.563 | 1.0 1.0 | 0.161 0.217 | 6.255 6.255 | — 0.359 | 1.96 2.35 | 3.85 3.29 | 0.43 0.75 | 42.74 30.91 | 1.51 2.22 |
| E24 | $\frac{{e}^{- s}}{s}$ | SOM dis- closed | 0.80 0.80 | 0.302 0.302 | 3.282 3.282 | 1.0 1.0 | 0.496 0.675 | 8.008 8.008 | — 0.46 | 1.70 | 3.94 3.47 | 1.21 1.73 | 16.15 11.87 | 1.55 1.53 |
| E25 | $\frac{{( s + 6 )}^{2}}{{s ( s + 1 )}^{2} ( s + 36 )}$ | SOM dis- closed | 0.80 0.80 | 0.304 0.304 | 4.989 4.989 | 1.0 1.0 | 0.495 0.673 | 12.173 12.173 | — 1.718 | 1.77 | 4.76 4.41 | 1.29 1.48 | 24.61 18.1 | 1.81 1.41 |
| E26 | $\frac{- 1.6 ( - 0.5 s + 1 )}{s ( 3 s + 1 )}$ | SOM dis- closed | −0.25 −0.25 | 0.296 0.296 | 9.685 9.685 | 1.0 1.0 | −0.156 −0.213 | 23.632 23.632 | — 1.356 | 1.77 | 9.46 8.68 | 0.41 0.502 | 151.3 111.2 | 1.82 1.57 |
| E27 | $\frac{{e}^{- s}}{{s}^{2}}$ | SOM dis- closed | Not possible to stabilize with PI controller Not possible to stabilize with PI controller | | | | | | | | | | | |
| E28 | $\frac{( - 2 s + 1 )}{{( s + 1 )}^{3}}$ | SOM dis- closed | 0.40 0.40 | 0.309 0.309 | 5.98 5.98 | 0.286 0.286 | 0.246 0.334 | 1.263 1.286 | — — | 2.14 | 7.04 8.80 | 1.56 2.77 | 8.62 10.56 | 1.83 3.10 |
| E29 | $\frac{( - s + 1 ) {e}^{- 2 s}}{{( s + 1 )}^{5}}$ | SOM dis- closed | 0.40 0.40 | 0.304 0.304 | 11.99 11.99 | 0.286 0.286 | 0.247 0.336 | 2.547 2.594 | — — | 1.70 | 11.66 12.28 | 1.17 1.74 | 11.63 11.87 | 1.18 1.69 |
| E30 | $\frac{9}{( s + 1 ) ( {s}^{2} + 2 s + 9 )}$ | SOM dis- closed | 1.25 1.25 | 0.322 0.322 | 1.40 1.40 | 0.556 0.556 | 0.752 1.023 | 0.905 0.922 | — 0.196 | 1.72 | 1.26 1.03 | 1.57 1.97 | 1.23 0.92 | 1.21 1.23 |
| E31 | $\frac{9}{( s + 1 ) ( {s}^{2} + s + 9 )}$ | SOM dis- closed | 0.75 0.75 | 0.31 0.31 | 1.40 1.40 | 0.429 0.429 | 0.460 0.626 | 0.554 0.564 | — — | 2.18 | 1.53 1.89 | 1.53 3.40 | 1.60 2.0 | 1.77 3.74 |
| E32 | $\frac{\begin{matrix}( {s}^{2} + 2 s + 9 ) \\ ( - 2 s + 1 ) ( s + 1 ) {e}^{- 2 s}\end{matrix}}{( {s}^{2} + 0.5 s + 1 ) {( 5 s + 1 )}^{2}}$ | SOM dis- closed | 0.12 0.12 | 0.30 0.30 | 15.04 15.04 | 0.519 0.519 | 0.074 0.101 | 8.667 8.826 | — — | 1.61 | 12.74 12.12 | 0.16 0.23 | 119.4 91.13 | 1.17 1.59 |
| E33 | $\frac{{e}^{- s}}{( 5 s - 1 )}$ | SOM dis- closed | 4.0 4.0 | 0.30 0.30 | 3.67 3.67 | 1.333 1.333 | 2.487 3.383 | 7.852 7.996 | — 0.514 | 2.33 | 7.96 5.75 | 10.15 10.88 | 3.81 2.44 | 3.12 2.24 |

* For pure time delay process (E21), obtain tₚ as end time of peak (or add a small time constant in simulation).

1) A method for closed loop tuning a PI/PID controller, comprising
running a setpoint experiment using a P-controller; and
tuning the PI/PID controller by obtaining a plurality of PI/PID-controller settings directly from three data from the setpoint experiment, wherein the three data are overshoot (Δyₚ−Δy_{∞})/Δy_{∞}, time to reach overshoot or first peak tₚ, and relative steady state output change b=Δy_{∞}/Δyₛ, wherein Δyₛ is a setpoint change, Δy_{∞} is a steady-state output change after setpoint step test, and Δyₚ is a peak output change at time tₚ.

2) The method of claim 1 further comprising
providing an estimate Δy_{∞}=0.45(Δyₚ+Δyᵤ) to speedup the closed-loop experiment, wherein Δy_{∞} is the steady-state output change after setpoint experiment, Δyᵤ is an output when the setpoint response reaches its first minimum, and Δyₚ is a peak output change at time tₚ.

3) The method of claim 1 further comprising
setting a controller integral time τ_{I} and a controller derivative time τ_{D} as
$${τ}_{I} = min ( 0.645 A \vert \frac{b}{( 1 - b )} \vert {t}_{p} F , 2.44 {t}_{p} F ) and {τ}_{D} = 0.14 {t}_{p} if A \vert \frac{b}{( 1 - b )} \vert \geq 1 ,$$
wherein, A=[1.55 (overshoot)²−2.159 (overshoot)+1.35], and F is a detuning parameter to detune a response.

4) The method of claim 3 wherein setting F<1 and setting an overshoot of around 0.3 speed up the closed loop response.

5) The method of 1 further comprising:
switching the controller to P-only mode;
making a setpoint change that gives an intermediate range for an overshoot;
recording an initial controller gain; and
obtaining, from the closed loop setpoint response experiment, the values of controller gain, an overshoot, a time from setpoint change to reach peak output and a relative steady state output change.

6) The method of claim 1, further comprising:
estimating the steady-state output change after setpoint step test variable by multiplying the sum of the two variables of setpoint change and peak output change by 0.45, to speed up the closed loop experiment to reach steady state.

7) The method of claim 1 further applied to a 30 tray distillation column temperature control loop with the depropanizer column, fed at tray 15, producing a distillate product that is 98 mole % propane.

8) The method of claim 1 further applied to a 30 tray distillation column temperature control loop with the depropanizer column, fed at tray 15, producing a distillate product that is 98 mole % propane, with the vapor pressure of propane being slightly higher than 200 psia at 110° F.

9) The method of claim 1 further applied to a 30 tray distillation column temperature control loop with the depropanizer column, fed at tray 15, producing a distillate product that is 98 mole % propane, with the vapor pressure of propane being slightly higher than 200 psia at 110° F., the liquid density of hydrocarbon system being about 30 lb/ft³.

10) The method of claim 1 further applied to a 30 tray distillation column temperature control loop with the depropanizer column, fed at tray 15, producing a distillate product that is 98 mole % propane, with the vapor pressure of propane being slightly higher than 200 psia at 110° F., the liquid density of hydrocarbon system being about 30 lb/ft³, the reboiler pressure being 202.6 psia, the design reflux ratio being 3.22, the design reboiler heat input being 1.02×10⁶ Btu/hr, the specified purity of distillate being 98 mol % propane, the specified impurity of propane being 1.0 mol %, and the boiler pressure being estimated by assuming a pressure drop over each tray of 5 inches of liquid in the high-pressure column.

11) A non-transitory computer-readable storage medium including computer executable instructions, wherein the instructions, when executed by a computer, cause the computer to perform a method for closed loop tuning a PI/PID controller, the method comprising:
running a setpoint experiment using a P-controller; and
tuning the PI/PID controller by obtaining a plurality of PI/PID-controller settings directly from three data from the setpoint experiment, wherein the three data are overshoot (Δyₚ−Δy_{∞})/Δy_{∞}, time to reach overshoot or first peak tₚ, and relative steady state output change b=Δy_{∞}/Δyₛ, wherein Δyₛ is a setpoint change, Δy_{∞} is a steady-state output change after setpoint step test, and Δyₚ is a peak output change at time tₚ.

12) The method of claim 11 further comprising
providing an estimate Δy_{∞}=0.45(Δyₚ+Δyᵤ) to speedup the closed-loop experiment, wherein Δy_{∞} is the steady-state output change after setpoint experiment, Δyᵤ is an output when the setpoint response reaches its first minimum, and Δyₚ is a peak output change at time tₚ.

13) The method of claim 11 further comprising
setting a controller integral time τ_{I} and a controller derivative time τ_{D} as
$${τ}_{I} = min ( 0.645 A \vert \frac{b}{( 1 - b )} \vert {t}_{p} F , 2.44 {t}_{p} F ) and {τ}_{D} = 0.14 {t}_{p} if A \vert \frac{b}{( 1 - b )} \vert \geq 1 ,$$
wherein, A=[1.55 (overshoot)²−2.159 (overshoot)+1.35], and F is a detuning parameter to detune a response.

14) The method of claim 13 wherein setting F<1 and setting an overshoot of around 0.3 speed up the closed loop response.

15) The method of 11 further comprising:
switching the controller to P-only mode;
making a setpoint change that gives an intermediate range for an overshoot;
recording an initial controller gain; and
obtaining, from the closed loop setpoint response experiment, the values of controller gain, an overshoot, a time from setpoint change to reach peak output and a relative steady state output change.

16) The method of claim 11, further comprising:
estimating the steady-state output change after setpoint step test variable by multiplying the sum of the two variables of setpoint change and peak output change by 0.45, to speed up the closed loop experiment to reach steady state.

17) The method of claim 11 further applied to a 30 tray distillation column temperature control loop with the depropanizer column, fed at tray 15, producing a distillate product that is 98 mole % propane.

18) The method of claim 11 further applied to a 30 tray distillation column temperature control loop with the depropanizer column, fed at tray 15, producing a distillate product that is 98 mole % propane, with the vapor pressure of propane being slightly higher than 200 psia at 110° F.

19) The method of claim 11 further applied to a 30 tray distillation column temperature control loop with the depropanizer column, fed at tray 15, producing a distillate product that is 98 mole % propane, with the vapor pressure of propane being slightly higher than 200 psia at 110° F., the liquid density of hydrocarbon system being about 30 lb/ft³.

20) The method of claim 11 further applied to a 30 tray distillation column temperature control loop with the depropanizer column, fed at tray 15, producing a distillate product that is 98 mole % propane, with the vapor pressure of propane being slightly higher than 200 psia at 110° F., the liquid density of hydrocarbon system being about 30 lb/ft³, the reboiler pressure being 202.6 psia, the design reflux ratio being 3.22, the design reboiler heat input being 1.02×10⁶ Btu/hr, the specified purity of distillate being 98 mol % propane, the specified impurity of propane being 1.0 mol %, and the boiler pressure being estimated by assuming a pressure drop over each tray of 5 inches of liquid in the high-pressure column.
